(19) United States
(12) Patent Application Publication
(10) Pub. No.: US 2025/0085672 A1
(43) Pub. Date: Mar. 13, 2025

(54) AI-BASED ORCHESTRATION IN INDUSTRIAL CONTROL SYSTEMS

(71) Applicant: Schneider Electric Systems USA, Inc., Foxboro, MA (US)

(72) Inventor: Shawky Adel Ismaeel ElBarbir, Alkhobar (SA)

(73) Assignee: Schneider Electric Systems USA, Inc., Foxboro, MA (US)

(21) Appl. No.: 18/882,408

(22) Filed: Sep. 11, 2024

Related U.S. Application Data
(60) Provisional application No. 63/538,168, filed on Sep. 13, 2023.

(51) Int. Cl. G05B 13/02

(52) U.S. Cl. CPC G05B 13/0265

(57) ABSTRACT

An autonomously or semi-autonomously performed method of orchestration in a process control system (PCS) is provided, including performing tasks for monitoring an industrial system, including the PCS, each of the tasks being performed using inputs related to functionality of controller(s) of the PCS, the controller(s) having at least one control function related to a physical aspect of the PCS. For each of the tasks performed, dynamic state(s) of the PCS and the PCS's controller(s) are analyzed using machine learning (ML) algorithm(s), the dynamic state(s) being affected by the inputs. The method further includes performing, causing to be performed, or advising performance of an action responsive to an output of the ML algorithm(s), the action adjusting at least one of functionality of the controller(s) and functionality of or a setting used by or affecting a component of the PCS that affects the controller(s).

### CROSS-REFERENCE TO RELATED APPLICATIONS

The present application claims the benefit of U.S. Provisional Patent Application Ser. No. 63/538,168, filed Sep. 13, 2023, entitled AI-BASED ORCHESTRATION IN INDUSTRIAL CONTROL SYSTEMS, the disclosure of which, in its entirety, is considered as being part of the present application, and thus, is incorporated herein by reference in its entirety.

### TECHNICAL FIELD

The present disclosure relates to system management and orchestration of process control systems, and more particularly, to autonomous artificial (AI)-based orchestration in an industrial control system.

### BACKGROUND

Operational technology (OT) uses a computing system to manage an industrial system, such as a production line, a mining operation, oil, and gas production, etc. Noting differences between OT and information technology (IT), IT manages flow of digital information and communication, whereas an OT connects, monitors, manages and secures industrial operations.

In the OT environment one or more process control systems (PCSs) (also known as industrial control systems (ICSs)) monitor and control industrial processes. An individual PCS includes a distributed control system (DCS) that includes multiple control processors (CPs) distributed through-out the industrial system for providing computerized and autonomous controls. The controls can be managed by a central operator supervisory controller, such as a supervisory control and data acquisition (SCADA) system. Each CP can supervise and control multiple field devices, such as sensors and actuators. In a large industrial system, controllers can interact with a vast number of field devices and programmable logic controllers (PLCs). An adjustment by one controller can affect another controller or control system, therefore Interprocess Communications (IPC) are established between controllers to exchange control information among control processors. A well-designed PCS aims to minimize the IPCs. In addition, control can be multidimensional, such as to control energy consumption, production rate, etc. An adjustment to address one dimension can affect other dimensions. Multivariable controller (MVC) algorithms are one of the solutions for addressing such scenarios.

Due to the integration and interactivity of components and subsystems in industrial systems and multidimensionality of OT (possibly among other reasons), orchestration for OT has not prevailed in the same way as it has for IT. This disclosure defines how to use machine learning (ML) to address the challenges of orchestration for OT.

### SUMMARY

The purpose and advantages of the below described illustrated embodiments will be set forth in and apparent from the description that follows. Additional advantages of the illustrated embodiments will be realized and attained by the devices, systems and methods particularly pointed out in the written description and claims hereof, as well as from the appended drawings. To achieve these and other advantages and in accordance with the purpose of the illustrated embodiments, in one aspect, disclosed is a computer-implemented method to perform orchestration in an industrial system having a process control system (PCS), the method being performed autonomously or semi-autonomously. The method includes performing a plurality of tasks for monitoring the industrial system, including the PCS. Each of the plurality of tasks being performed uses a plurality of inputs related to functionality of at least one controller of the PCS. The at least one controller includes at least one control function related to a physical aspect of the PCS.

The method further includes, for each of the plurality of tasks performed, analyzing, using at least one machine learning (ML) algorithm, one or more dynamic states of the PCS and the PCS's at least one controller. The one or more dynamic states are affected by the plurality of inputs.

The method further includes, responsive to an output of the at least one ML algorithm, performing an action, causing the action to be performed, or advising the action to be performed. The action adjusts at least one of functionality of the at least one controller and functionality of or a setting used by or affecting a component of the PCS that affects the at least one controller.

In one or more embodiments, at least a portion of the multiple tasks can be performed at a same time.

In one or more embodiments, the action can include an adjustment to loading of at least one of the PCS, a network of the PCS, and Interprocess communication (IPC) constraints between the at least one controller.

In one or more embodiments, a condition of the plurality of inputs can trigger performance of a task of the plurality of tasks.

In one or more embodiments, the condition can include at least one of installation within the PCS of a new physical component, installation of new software on a processing device of the PCS, deployment of new logic on the at least one controller that affects control of the one or more physical aspects of the PCS, and identification of a loading problem.

In one or more embodiments, the one or more dynamic states of the PCS can be based on at least one of: loading capacity of the at least one controller, current loading of the at least one controller, current loading of the PCS, segregation requirements of the PCS, system architecture of the PCS, current loading of the IPC, and current loading of the network of the PCS.

In one or more embodiments, the at least one ML algorithm can include at least one of an ML reinforcement algorithm, a constraint satisfaction algorithm, and a probabilistic ML algorithm.

In one or more embodiments, the action can be a corrective action for at least one of an identified present fault and/or failure and a predicted fault and/or failure, an update to a collection of symptoms indicative of a present or predicted fault and/or failure used to analyze the one or more dynamic states of the PCS, and/or a collection of diagnostic guidelines used to diagnostically analyze the one or more dynamic states of the PCS.

In one or more embodiments, the condition of the plurality of inputs can trigger performance of a task of the plurality of tasks, wherein the condition can include at least one of running and/or historical system logs of the PCS, running and/or historical network monitoring logs of a network used by the PCS, and running and/or historical event logs of events occurring and/or that occurred in association with operation of the PCS.

In one or more embodiments, the one or more dynamic states of the PCS can be based on at least one of: the collection of diagnostic guidelines, an operator action journal (OAJ) that describes timestamped operator actions associated with the at least one controller, and the collection of symptoms.

In one or more embodiments, the at least one ML algorithm can include at least one of deep learning for natural language processing and a probabilistic ML algorithm.

In one or more embodiments, the action can include at least one of correction of a detected misconfiguration associated with configuration of the PCS, adjustment to a collection of configuration guidelines for the PCS that are used for detecting misconfigurations associated with the configuration of the PCS, and adjustment to misconfiguration validation rules for validating the correction of the detected misconfiguration and/or the adjustment to the collection of configuration guidelines.

In one or more embodiments, a condition of the plurality of inputs can trigger performance of a task of the plurality of tasks, wherein the condition can include at least one of a hardware configuration of the PCS, a software configuration of the PCS, and a configuration of logic installed on the at least one controller.

In one or more embodiments, the one or more dynamic states of the PCS can be based on at least one of: performance indicators of the PCS and the collection of configuration guidelines of the PCS.

In one or more embodiments, the at least one ML algorithm can include at least one of an ML reinforcement algorithm, a constraint satisfaction algorithm, and a probabilistic ML algorithm.

In one or more embodiments, analyzing the one or more dynamic states of the PCS using the ML algorithm can include analyzing the one or more dynamic states in view of one or more respective corresponding desired states.

In one or more embodiments, the one or more respective corresponding desired states can be dynamic.

In one or more embodiments, the action can further include adjustment to determination of a future action.

In one or more embodiments, an orchestration system is provided. The orchestration system includes at least one memory configured to store a plurality of programmable instructions and at least one processing device in communication with the memory. The processing device, upon execution of the plurality of programmable instructions can be configured to perform the disclosed method.

In one or more embodiments, a non-transitory computer readable storage medium and one or more computer programs embedded therein are provided. The computer programs comprising instructions, which when executed by a computer system, cause the computer system to perform the disclosed method.

### BRIEF DESCRIPTION OF THE DRAWINGS

A more detailed description of the disclosure, briefly summarized above, may be had by reference to various embodiments, some of which are illustrated in the appended drawings. While the appended drawings illustrate select embodiments of this disclosure, these drawings are not to be considered limiting of its scope, for the disclosure may admit to other equally effective embodiments.

FIG. 1 shows an example system architecture of an industrial control system provided with an orchestration solution that interfaces with various components of the industrial system, and with a machine learning (ML) engine that interfaces with the orchestration solution in accordance with embodiments of the disclosure;

FIG. 2 is a block diagram showing an example set of inputs received by a machine learning engine that communicates with an orchestration module associated with an industrial control system, in accordance with embodiments of the disclosure;

FIG. 3 is a block diagram showing an example set of expected outputs from a machine learning engine that communicates with an orchestration module that provides orchestration to an industrial system, in accordance with embodiments of the disclosure;

FIG. 4 shows an example basic workflow used for ML algorithms applied to orchestration of a process control system of an industrial system, in accordance with embodiments of the disclosure;

FIG. 5 is a block diagram of some example ML models used for applying AI to orchestration of a process control system (PCS) of an industrial system, in accordance with embodiments of the disclosure;

FIG. 6 is a flowchart of an example method for load management used by ML-based orchestration of an industrial system, in accordance with embodiments of the disclosure;

FIG. 7 is a flowchart of an example method for root-cause identification associated with fault or failure detection, as well as predictive alerts of components' failure used by ML-based orchestration of an industrial system, in accordance with embodiments of the disclosure;

FIG. 8 is a flowchart of an example method for misconfiguration identification and correction, as well as enhancement of misconfiguration validation rules used by ML-based orchestration of an industrial system, in accordance with embodiments of the disclosure;

FIG. 8A is a plurality of plots showing graphical representation of performance indicators of a PCS of the industrial system, in accordance with embodiments of the disclosure;

FIG. 9 is a flowchart of an example method used for ML-based orchestration of an industrial system, in accordance with embodiments of the disclosure; and

FIG. 10 is a block diagram of an exemplary computer system that could be used to implement an orchestration module and/or an ML engine for ML-based orchestration of an industrial system, in accordance with embodiments of the disclosure.

Identical reference numerals have been used, where possible, to designate identical elements that are common to the figures. However, elements disclosed in one embodiment may be beneficially utilized on other embodiments without specific recitation.

### DETAILED DESCRIPTION

Orchestration has the ability to be the heart of an industrial system. It has the ability to interface with all Process Control System (PCS) components. Through these interfaces, orchestration automates operation of components of the PCS. Also, it monitors health of the components and coordinates recovery from faults and failure conditions. Orchestration further discovers, validates, and controls changes in the industrial system. Deployment of an orchestration solution has the potential advantage of providing efficiency and sustainability of the industrial system. This disclosure addresses challenges of orchestration for operational technology (OT). The disclosed orchestration solution is empowered with AI technology to address complexity and multidimensionality challenges and a need for continuous improvement of orchestration performance through a number of machine learning (ML) algorithms.

The present disclosure applies machine learning to provide an automated orchestration solution for monitoring a PCS of an industrial system. The PCS includes at least one controller. Each of the controllers has logic deployed on it that causes the controllers to perform a control function that controls one or more physical aspects of the industrial system. The automated and autonomous orchestration solution includes performing tasks for monitoring the process control system. Each task can be performed in response to a trigger. Alternatively, the tasks can be performed continuously or at timed intervals. Possible triggers include triggers that are related to functionality of the controllers. Each task includes analyzing one or more dynamic states of the PCS using ML and performing, causing performance of, and/or advising performance of an action responsive to a result of the machine learning. The action can adjust conditions for identifying triggers, references used for performance of the ML analysis, functionality of one or more of the controllers, and functionality of or a setting used by or affecting a component of the PCS that affects the at least one controller. In one or more embodiments, the action can include several actions that adjust all of the above.

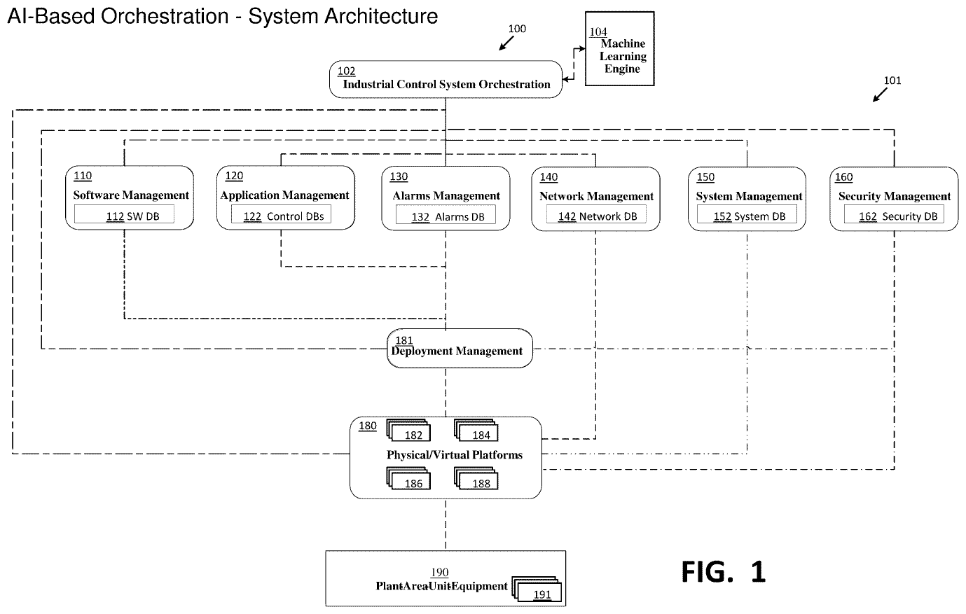

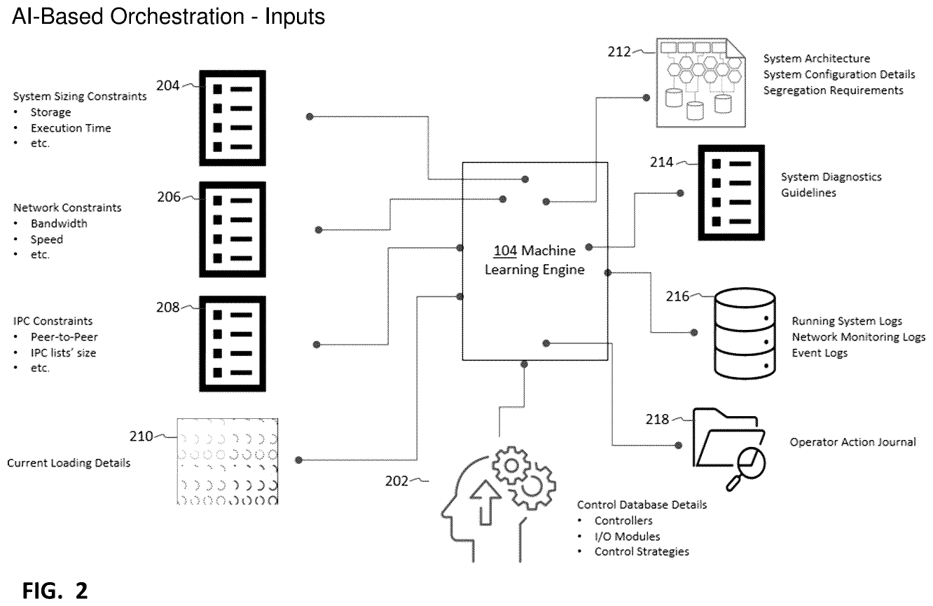

Reference will now be made to the drawings wherein like reference numerals identify similar structural features or aspects of the subject disclosure. For purposes of explanation and illustration, and not limitation, a block diagram of an exemplary embodiment of an industrial system in accordance with the disclosure is shown in FIG. 1 and is designated generally by reference character 100. Other embodiments of industrial system 100 in accordance with the disclosure, or aspects thereof, are provided in FIGS. 2-8, as will be described.

Unless defined otherwise, all technical and scientific terms used herein have the same meaning as commonly understood by one of ordinary skill in the art to which this disclosure belongs. Although any methods and materials similar or equivalent to those described herein can also be used in the practice or testing of the present disclosure, exemplary methods and materials are now described.

It must be noted that as used herein and in the appended claims, the singular forms “a,” “an,” and “the” include plural referents unless the context clearly dictates otherwise. Thus, for example, reference to “a stimulus” includes a plurality of such stimuli and reference to “the signal” includes reference to one or more signals and equivalents thereof known to those skilled in the art, and so forth. It is to be appreciated the embodiments of this disclosure as discussed below are implemented using a software algorithm, program, or code that can reside on a computer useable medium for enabling execution on a machine having a computer processor. The machine can include memory storage configured to provide output from execution of the computer algorithm or program.

As used herein, the term “software” is meant to be synonymous with any logic, code, or program that can be executed by a processor of a host computer, regardless of whether the implementation is in hardware, firmware or as a software computer product available on a memory storage device or for download from a remote machine. The embodiments described herein include such software to implement the equations, relationships, and algorithms described above. One skilled in the art will appreciate further features and advantages of the disclosure based on the above-described embodiments. Accordingly, the disclosure is not to be limited by what has been particularly shown and described, except as indicated by the appended claims.

FIG. 1 is a block-flow diagram illustrating an example architecture of industrial system 100 in which an orchestration module 102 applies orchestration to PCS 101 of industrial system 100. System orchestration module 102 uses ML algorithms processed by ML engine 104 to provide the orchestration, overriding complexity and multidimensionality challenges.

PCS 101 of industrial system 100 is not limited to the architecture or components shown. Industrial system 100 is an operational system that includes physical/virtual platforms 180 and plant-area-unit-equipment (PAUE) 190. Physical/virtual platforms 180 include physical and/or virtual components, and further include one or more controller 186 and one or more I/O module 188. PAUE 190 interacts with at least one physical characteristic of, acting on, or affected by industrial system 100, such as by sensing one or more of the physical characteristic(s) of industrial system 100 or performing a physical act that changes one or more of the physical characteristic(s). PAUE 190 includes one or more controlled devices that are controlled by controllers 186. Additionally, devices of PAUE 190 can include sensors (also referred to as meters) that provide measurement data about physical characteristic(s) of industrial system 100 to controllers 186. Measurement data provided by sensors of PAUE 190 to controllers 186 can be used to control one or more devices of PAUE 190, such as actuators, sensors, alarms (e.g., a visual or audio indicator, such as an LED or horn), edge-devices, and PLCs. The edge-devices and PLCs are field devices that manipulate a physical process such as by manipulating a valve actuator, pump, or motor relay.

In the example shown, PCS 101 of industrial system 100 includes software management 110, application management 120, alarms management 130, network management 140, system management 150, security management 160, deployment management 181, execution engines/operating systems 182/184 hosted on physical/virtual platforms 180. Deployment management 181 manages deployment of applications, software, rules, and configurations to target execution engines/operating systems 182/184. Physical/virtual platforms 180 host the deployed applications, software, and configurations.

Software management 110 includes or accesses a software (SW) database (DB) 112 that stores software, and further manages the stored software and deployment of the stored software by deployment management 181. Application management 120 includes or accesses control databases 122 and further manages control databases 122 and deployment of the control databases 122 by deployment management 181 to controllers 186 and I/O modules 188. The undeployed control databases 122 are stored offline in an integrated development environment (IDE) a control database configuration tool. Once deployed, a copy of control databases 122 are stored online on a controller 186 or I/O modules 188. These control databases 122 can be function blocks, or the like, that enable functionality of the controllers 186 upon which they are deployed.

Alarms management 130 includes or accesses an alarms collection (e.g., database (DB)) 132 that stores alarms, and further manages the alarms collection and alarms including deployment of the alarms by deployment management 181. Alarms can be deployed, for example, by deployment of the different alarm settings, such as, without limitation, an alarm's setpoint, criticality, deadband, etc. Network management 140 manages a network that couples the components of PCS 101 (e.g., components 110, 120, 130, 140, 150, 160, 180, and 181, also referred to as PCS components). Network management 140 includes or accesses a network database 142 that stores network software and network data used and/or output for operation of the network, and further manages and/or monitors the network database, the network software, and/or the network data. System management 150 manages includes or accesses a system database 152 that stores system software and system data, and further manages system database 152, the system software, and/or the system data. Security management 160 includes or accesses a security database 162 that stores security software and security data, and further manages the security database, security software, and/or security data, including deployment of the security software by deployment management 181.

Software management 110, application management 120, alarms management 130, network management 140, system management 150, and security management 160 can access and/or store data that is relevant to their operation, such as guidelines, specifications, configurations, operator data, etc., in the corresponding database (e.g., of databases 112, 122, 132, 142, 152, and 162). Orchestration module 102 and ML engine 104 can access each of software management 110, application management 120, alarms management 130, network management 140, system management 150, and security management 160, such as for accessing or receiving input data and/or for storing or writing output data.

The architecture of industrial system 100 is not limited to the example shown in FIG. 1. Additional individual components can be added. Orchestration module 102 and ML engine 104 provide orchestration to PCS 101 and interface with the different components of PCS 101 using proprietary or open protocols.

With reference to FIG. 2, ML engine 104 is shown with the capacity to receive various inputs to which ML algorithms are applied for performance of the orchestration. The inputs are used by orchestration module 102 (shown in FIG. 1) and ML engine 104 to execute orchestration tasks supported by ML, such as load management (including load balancing and load optimization, for example), root cause identification, and misconfiguration identification tasks, without limitation to these specific tasks. Some of the inputs can be obtained from an appropriate database of databases 112, 122, 132, 142, 152, 162 shown in FIG. 1 and others can be obtained from components of PCS 101.

The inputs include control database details 202 provided from control databases 122 shown in FIG. 1. The control database details represent parameters configured in PCS 101 related to controllers 186, I/O modules 188, control strategies, etc. For example, the parameters represented for controllers 186 can include configuration parameters that define how controllers 186 execute the deployed applications (e.g., a basic execution cycle) and how the controllers 186 interface with other components of PCS 101. These configuration parameters are based on the make/model of controllers 186. The parameters represented for the I/O modules 188 can include configuration parameters that define how the I/O modules 188 interface with controllers 186 and define the connected field devices (sensors, actuators, etc.), including specifying types and I/O settings of the field devices. The parameters represented for the control strategies represent enclosed function blocks, their connections, and their configuration settings.

Other inputs can optionally include one or more of the following inputs: System sizing constraints 204, including, for example, system sizing constraints related to storage (e.g., design capacities), execution time (e.g., execution speed), etc. System sizing constraints 204 are obtained from providers of the system components of PCS 101. Network constraints 206, include, for example, network constraints related to bandwidth (e.g., capacity and availability), network speed, etc. Network constraints 206 are obtained from providers of network components used by PCS 101.

Interprocess communication (IPC) constraints 208 for communication between processes executed by controllers 186, including, for example, peer-to-peer communication (e.g., protocols and rules), IPC lists' size (that defines maximum number of variables in such lists), etc. IPC constraints 208 are obtained from providers of the controllers 186 and control software of PCS 101. Current loading details 210, are obtained from the running (also referred to as online) components of PCS 101.

System specifications 212, include, for example, system architecture, system configuration details, segregation requirements, etc. System specifications 212 are obtained from a system design package and are validated by system discovery services (not shown). System diagnostics guidelines 214, are obtained from providers of components of PCS 101. Logs 216, include, for example, system logs, network monitoring logs, event logs, etc. Logs 216 can be running logs that include logged data obtained from the running components of PCS 101. Operator action journal (OAJ) 218 include logged data about actions executed by plant operators. Network monitoring logs include logged data about activity or status of the PCS' network (also referred to as the PCS network). Event logs include logged data about identified events, e.g., that occurred in PCS 101 or the PCS network. OAJ 218 is obtained from the running components of PCS 101. The inputs can include some or all of these examples. The inputs are not limited to the examples described, as other inputs can be provided as well.

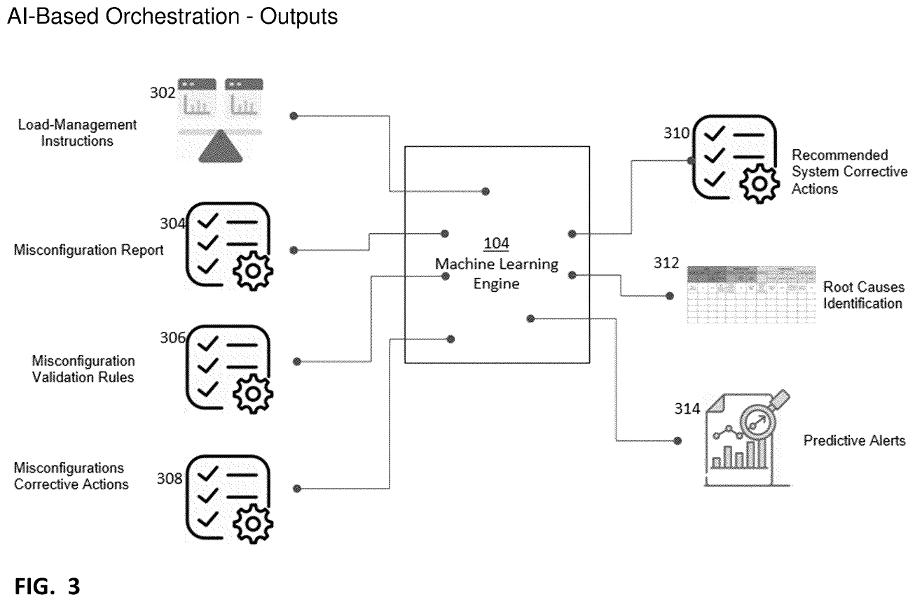

With reference to FIG. 3, ML engine 104 is shown with various outputs that result from application of the ML algorithms. The outputs include information that affects orchestration involving PCS 101 (shown in FIG. 1). At least one of the outputs affects operation of PCS 101. Examples of outputs include load-management instructions 302, which can include instructions for load management of controllers 186 (shown in FIG. 1) as well as other components of PCS 101; a misconfiguration report 304, which can include a report about misconfigurations within controllers 186 as well as other components of PCS 101; misconfiguration validation rules 306, which can be provided to orchestration module 102 and/or ML engine 104 for updating rules applied when identifying misconfigurations (within controllers 186 as well as other components of PCS 101) during orchestration; misconfigurations corrective actions 308, which can be advised to be applied to, applied to, or caused to be applied to controllers 186 as well as other components of PCS 101 for correcting identified misconfigurations; system corrective actions 310, which can be advised to be applied to, applied to, or caused to be applied to controllers 186 as well as other components of PCS 101 for addressing identified faults or predicted faults; root causes identification 312 for analyzed faults within controllers 186 as well as other components of PCS 101 and determining both root causes and corrective actions to controllers 186 as well as other components of PCS 101; and predictive alerts 314 about faults predicted within controllers 186 as well as other components of PCS 101. The outputs can include some or all of these examples. The outputs are not limited to the examples described, as other outputs can be provided as well.

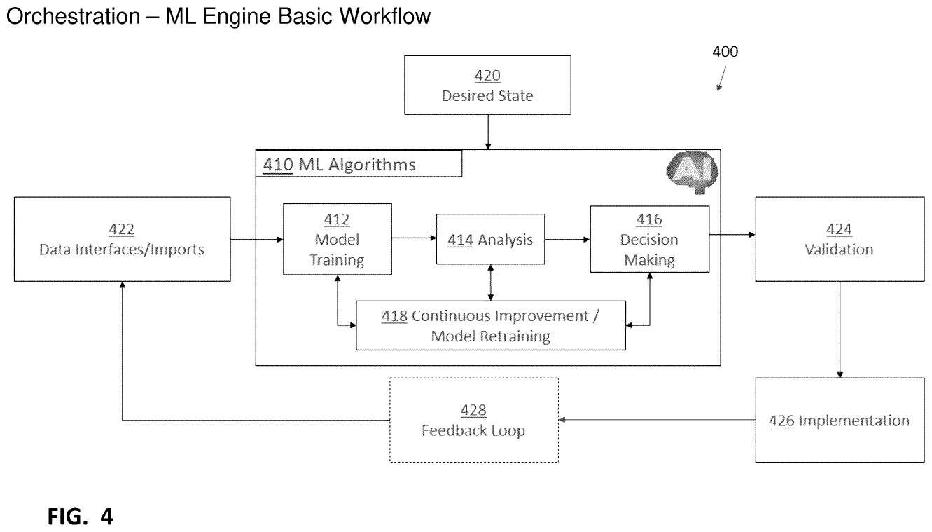

With reference to FIG. 4, a basic workflow 400 used for each of the ML algorithms as applied to orchestration of a PCS of an industrial system (such as PCS 101) explained in this disclosure shows a cycle starting with reading the inputs, analyzing the inputs including comparison with a desired state, making appropriate decisions based on the analysis, validating and implementing the decisions, and evaluating improvement and/or rectification of the PCS. ML algorithms 410 is a closed loop including ML model training at block 412, analysis at block 414, decision making at block 416, and continuous improvement and/or ML model retraining at block 418.

The ML algorithm being used (referred to as ML algorithm 410) receives a desired state from block 420 and applicable inputs from block 422. The inputs are read through corresponding interfaces and import methods. The inputs are used at block 412 to train or retrain ML models that are used by the ML algorithm. At block 414, the inputs are analyzed and compared to the desired states. At block 416, outputs of the analysis are used to make appropriate decisions. steps 412, 414 and 416 are continuously improved at block 418, which can include causing the ML models to be retrained at 412. Output of any of blocks 412, 414, and 416 can be processed at block 418 to continuously improve any of blocks 412, 414, and 416.

Outputs of block 410 (which include decisions output by block 416) are optionally validated at block 424. The validated outputs are implemented on PCS as it is running at block 426 (e.g., in real time). At block 428, an outer loop including blocks 420, 422, 424 (optionally), 426, and 428 is closed by measuring an improvement of the PCS after implementing the outputs of block 410 and causing reevaluation of the inputs.

ML algorithms 410 are capable of operating continuously and autonomously, without need for user intervention. Various degrees of user intervention can be required or allowed. The degree of user intervention required or allowed can be selected via user settings. User intervention settings can be adjusted by an operator having the proper authority. The user settings can be adjusted to select which blocks of ML algorithms 410 require or allow user intervention, whether the user intervention is allowed on demand or when prompted, and authorization needed by a user to enter input. Examples of user input can include responding to a prompt to approve a decision or determination made by a block of ML algorithms 410 and allow processing to continue, overriding a decision or determination made by a block of ML algorithms 410 on demand, halting processing on demand, changing a parameter on demand, etc.

The outer loop receives input from a user and/or a processing device. Desired state 420 provides a default or a user entered desired state. The desired state output by desired state 420 can be an initial input that remains static or can be a dynamic input that a user can adjust over time. Data interfaces/imports 422 provides information about the orchestration task, such as about load management, root cause identification, and misconfiguration identification tasks, without limitation to these specific orchestration tasks. The information output by data interfaces/imports 422 is provided as an input to ML algorithms 410, and can include, for example, information about: operation or state of a system, software or hardware used by the system, system configurations, guidelines or requirements for the system or its components, logs generated by the system or its components, etc. Some of this information can be based on user input and can be updated by a user. Some of the data output by data interfaces/imports 422 can be an initial input that remains static or can be a dynamic input that a user can adjust over time. Blocks 424, 426, and 428 can be performed manually or automatically, with little or no human intervention.

One or more user interfaces (not shown) can be provided to interact with any of the blocks of basic workflow 400. The user interface can be provided on a device that is remote from the processing devices that execute the corresponding blocks of basic workflow 400.

Accordingly, ML algorithms 410 can be configured to operate autonomously without any user intervention or can be configured to allow or require user intervention. Similarly, once initial input is provided by blocks 420 and 422, any or all of blocks 420, 422, 424, 426, 428 can be configured to operate autonomously without any user intervention or can be configured to allow or require user intervention. Basic workflow 400 is referred to being configured to operate autonomously or semi-autonomously when it includes blocks that are configured to operate automatically once initial input is received, but may include one or more blocks that can be configured to allow or require user intervention.

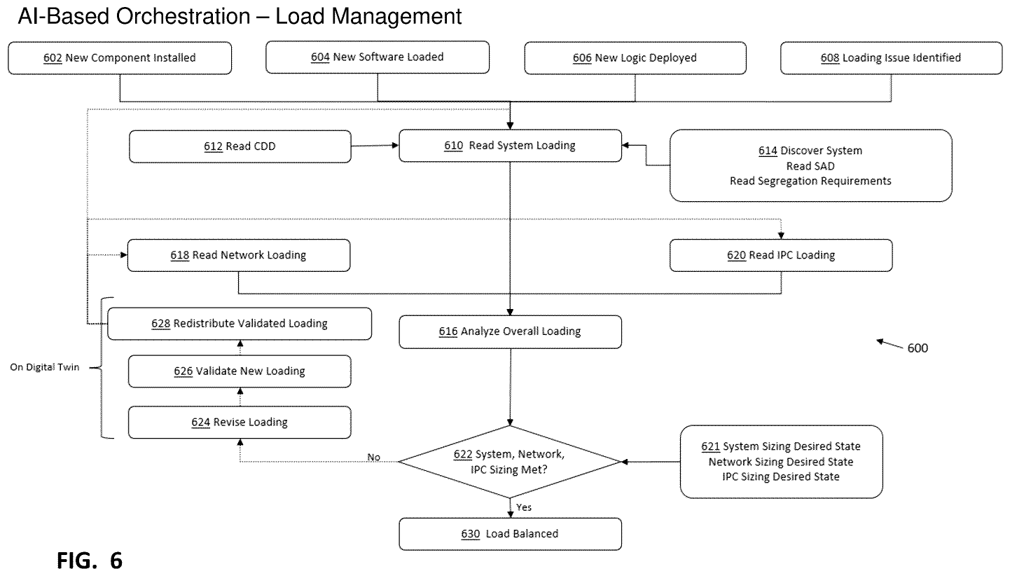

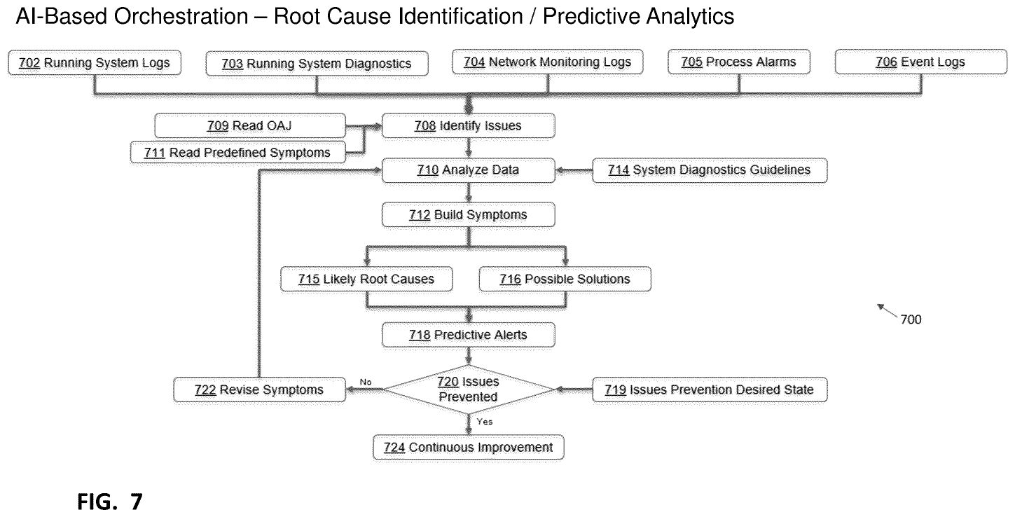

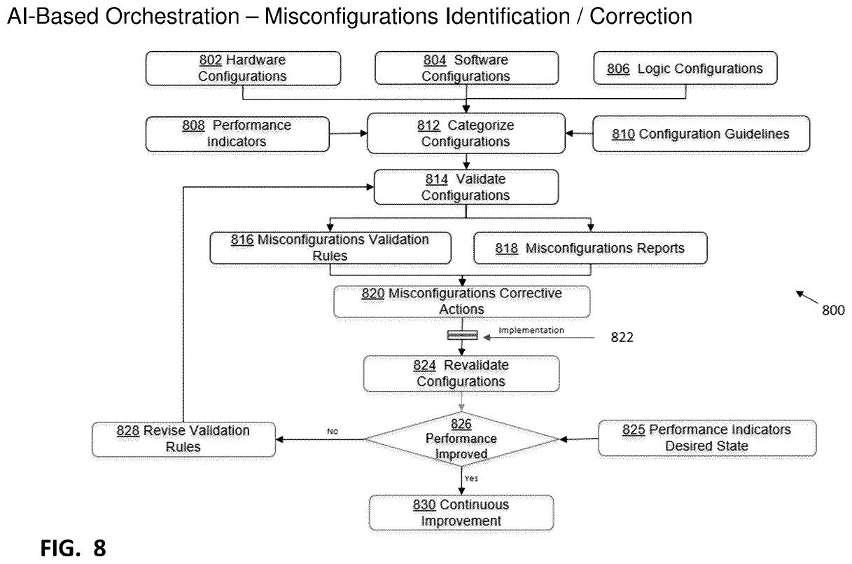

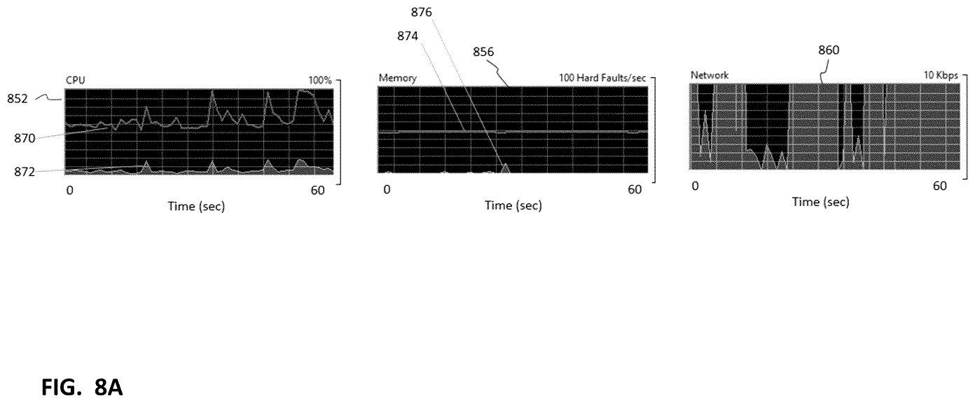

Some example use cases using ML algorithms 410 include load management (as shown and described with respect to FIG. 6), root cause identification and/or predictive analytics (as shown and described with respect to FIG. 7), and misconfigurations identification and/or correction (as shown and described with respect to FIG. 8). Use cases for workflow 400 are not limited to the three example use cases shown in FIGS. 6-8, as other use cases can be based on the same workflow.

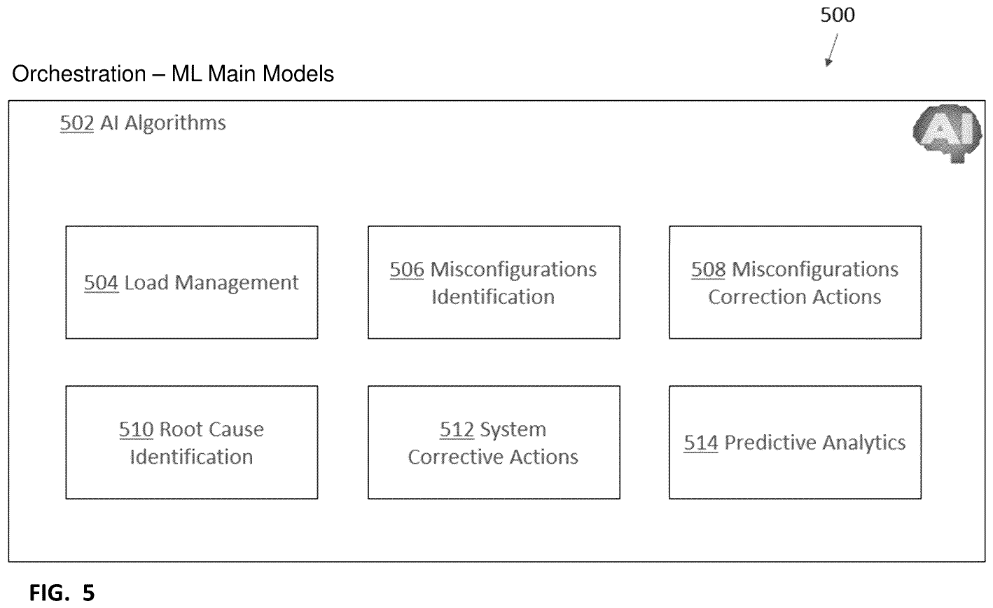

With reference to FIG. 5, a block diagram of the main ML models covered by this disclosure are shown. The block diagram 500 shows three main ML models explained in following sections.

A load management model at block 504, autonomously and continuously monitors the PCS, manages new loading or deployments to a best fit component, and rectify any identified loading issues.

A misconfigurations identification model at block 506 and/or a correction ML model at block 508, autonomously and continuously monitor and/or validate changes in the PCS and identify misconfigurations in real time and/or decide corrective actions to correct misconfigurations that were identified.

Root cause identification model at block 510 and/or corrective actions model at block 512, autonomously and continuously monitor logs and identify issues and/or their possible solutions.

Predictive analytics model at block 514 predicts future issues using outputs from blocks 510 and 512 and based on a collection (e.g., database, library, list, etc.) of identified symptoms.

With reference now to FIGS. 6-9, shown are flowcharts demonstrating implementation of various exemplary methods included in the process of orchestration performed by an orchestration module using ML (such as orchestration module 102 using ML engine 104 shown in FIG. 1) in accordance with certain embodiments. It is noted that the order of operations shown in FIGS. 6-9 is not required, so in principle, the various operations may be performed out of the illustrated order. Also, certain operations may be skipped, different operations may be added or substituted, some operations may be performed in parallel instead of strictly sequentially, or selected operations or groups of operations may be performed in a separate application following the embodiments described herein. Orchestration performed in accordance with the disclosure can include one or more of the methods shown in FIGS. 6-9.

With reference to FIG. 6, a flowchart 600 is illustrated of an example orchestration method for a load management workflow performed during orchestration. Blocks 602, 604, 606, and 608 include different possible triggers that can initiate the workflow. Detection of any of the triggers can cause execution of block 610. The method is not limited to the example triggers that are shown. Other triggers or different triggers could be used. At least one of the triggers includes a trigger caused by an aspect of a PCS (such as PCS 101 shown in FIG. 1).

The example triggers shown include new component installed 602, which can include a new controller (e.g., of controllers 186 shown in FIG. 1) in the PCS or a new field device in PAUE (e.g., PAUE 190 shown in FIG. 1) or another new type of component of the PCS; new software loaded 604; new logic deployed 606, which refers to deployment of logic on a controller of the PCS (e.g., controllers 186 shown in FIG. 1), such as deployment of a function block or the equivalent; loading issue identified 608, which can include identification of a loading issue in the PCS or within one or more other components of industrial system 100.

Upon detection of one of the triggers, block 610 can be executed. At block 610, system loading conditions are read from components of the PCS as they are running. These system loading conditions can be read through proprietary or open protocols. Additionally, at block 612, the control database details (CDD) are read (e.g., from an appropriate database of databases 112, 122, 132, 142, 152, or 162 shown in FIG. 1). The control database details include control data associated with the PCS (such as control data 202 shown in FIG. 2). In addition, system design specifications (such as system specifications 212 shown in FIG. 2) can be read at block 614 by execution of system discovery and/or from a system design package. Reading the system specifications can include reading a system architecture drawing (SAD) and segregation requirements. The segregation requirements can segregate certain controllers of the PCS and/or PAUE devices of the PAUE into segregated units or parallel units, that each include one or more pieces of equipment, or segregated areas or parallel areas that each include one or more units, etc. Some or all of the system design specifications read at block 614 can be input by a user or other source.

It is noted that blocks 602, 604, 606, 608, 612, 614, 618, and 620 correlate to output from block 422 shown in FIG. 4, which is provided as input for processing by ML algorithms (shown as ML algorithms 410 in FIG. 4). Any of blocks 602, 604, 606, 608, 612, 614, 618, and 620 can be revised by decisions output by the ML algorithms (e.g., at blocks 624, 626, 628, which correlate with feedback loop block 428 of FIG. 4), effectively providing a feedback loop.

At block 616, analysis of the overall loading read at block 610 is performed using current loading details (such as current loading details 208 shown in FIG. 2). The overall loading analyzed includes analysis of the system loading read at block 610 and network loading (e.g., of a control network of the PCS) that is read at block 618, and analysis of IPC loading that is read at block 620.

The analysis includes a survey of physical/virtual platforms of the PCS (such as physical/virtual platforms 180 shown in FIG. 1) and identification of a target physical/virtual platform that is available and can optimally resolve the loading issue, while taking into consideration multidimensional constraints (e.g., sizing requirements, segregation requirements, architectural constraints). The IPC loading read at block 620 refers to loading of communication between processes executing on controllers of the physical/virtual platforms. Details about the loading of any of the system, network, and IPC can be similar to the current loading details input 210 shown in FIG. 2.

It is noted that block 616 correlates to block 414 shown in FIG. 4, which presents the analysis processed by ML algorithms (shown as ML algorithms 410 in FIG. 4).

If a new component is installed in the PCS, the load management workflow is configured to be triggered to interface with the deployment management (such as deployment management block 181 in FIG. 1) to identify a workload to be loaded (i.e., deployed) to the new component. Here, the term “workload” refers to a control database (e.g., of control databases 122, shown in FIG. 1) for a specific controller (e.g., controller 186, shown in FIG. 1) or I/O module (e.g., I/O module 188 shown in FIG. 1). The load management algorithm is configured to evaluate the impact of this workload deployment on the load balance of the overall industrial system (e.g., the entire PCS or optionally a selected portion of the PCS). This can be executed by reading the current system (e.g., the overall industrial system or the PCS), network, and IPC loading, and validating with desired states (e.g., one or more desired states 420 shown in FIG. 4).

The current loading is configured to read for any or all components of the PCS. Table 1 illustrates a current loading read for components of the PCS.

TABLE 1

| LoadingDate Time | Component | CPU_Loading | MEM_Loading | IPC_Loading | Network_Loading |
|---|---|---|---|---|---|
| Mar. 22, 2021 3:55:30 AM | Component1 | 44% | 60% | 70% | 5% |
| Mar. 22, 2021 3:55:30 AM | Component2 | 45% | 55% | 60% | 4% |
| Mar. 22, 2021 3:55:30 AM | Component3 | 48% | 57% | 55% | 2% |
| Mar. 22, 2021 3:55:30 AM | Component4 | 50% | 58% | 65% | 4% |
| Mar. 22, 2021 3:55:30 AM | Component5 | 48% | 56% | 58% | 3% |
| Mar. 22, 2021 3:55:31 AM | Component6 | 44% | 60% | 66% | 5% |
| Mar. 22, 2021 3:55:31 AM | Component7 | 45% | 55% | 64% | 5% |
| Mar. 22, 2021 3:55:31 AM | Component8 | 48% | 57% | 62% | 4% |

The desired states are read at block 621. Table 2 illustrates some example desired states that were read.

TABLE 2

| LoadingParameter | DesiredState |
|---|---|
| CPU_Loading_Max | 50% |
| MEM_Loading_Max | 60% |
| IPC_Loading_Max | 70% |
| Network_Loading_Max | 5% |

It is noted that block 621 correlates to block 420 shown in FIG. 4, which is provided as desired state for processing by ML algorithms (shown as ML algorithms 410 in FIG. 4).

At block 622, a determination is made whether a desired state is reached by a current state of the system, network. Both the current state and the desired state can be dynamic. For example, at block 622, it can be determined whether sizing requirements are currently met. The sizing requirements of the system, network, and IPC represent the desired state. These sizing requirements and the criteria for meeting them (which is the desired state) can be updated manually, as indicted by block 621. It is noted that the decision making provided by block 622 corresponds to the output from decision making block 416 shown in FIG. 4. The sizing requirements can be included in system sizing constraints 204, network constraints 206, and/or IPC constraints 208 shown in FIG. 2. The analysis performed at block 616 and the determination made at block 622 use ML (such as by invoking algorithms executed by ML engine 104 shown in FIG. 1). The ML algorithms used can include reinforcement learning (e.g., multi-agent reinforcement learning (MARL)) and/or an algorithm to solve constraint satisfaction problems (CSPs).

If the determination at block 622 is that any of the sizing requirements are not met, then blocks 624, 626, and 628 are performed, optionally using a digital twin that models or simulates the industrial system.

An alternative to using the digital twin can include, for example, using a maintenance training simulator (MTS) (not shown) that is an offline replica of the system (PCS or industrial system) when online. The MTS is used for testing and validating modifications offline before deploying to the online system. Another alternative, instead of using an MTS, includes applying risk assessment and mitigation actions to allow direct revision of the loading in the online system. After the new loading is validated, the mitigation actions can be removed.

Additionally, if the determination at block 622 is that any of the sizing requirements are not met, adjustments can be made to any of the segregation requirements read at block 614 and/or validation rules used to validate adjustments that are made (before or after implementation) (e.g., in accordance with desired states read at block 621). Performance of blocks 624, 626, and/or 628 can use ML algorithms. At block 624, loading is revised by adjusting at least one of IPC, system, and network loading. System, network, and IPC loading can be adjusted by moving part of the workload from one controller to another. This will affect all of the three (system, network and IPC) loadings concurrently. In this way, comprehensive overseeing is executed by the ML algorithms to maintain balance in view of all criteria and in view of achieving all target desired states.

At block 626, the new loading (following the adjustment) is validated. Validation can be performed locally, virtually, or remotely on a cloud-based device. At block 628, the validated loading is redistributed. This is implemented by an orchestration module (e.g., orchestration module 102 in FIG. 1) redeploying (e.g., adding, revising, and/or replacing) components, software and/or logic to the identified target physical/virtual platforms, e.g., by executing load management instructions 302, shown in FIG. 3.

It is noted that blocks 624 and 626 correlate to block 424 shown in FIG. 4, which represents the validation process following the execution of the ML Algorithms (shown as ML algorithms 410 in FIG. 4).

It is also noted that block 628 correlates to block 426 shown in FIG. 4, which represents the implementation of the decisions made by the ML Algorithms (shown as ML algorithms 410 in FIG. 4).

The loading can be revised among any or all components of the PCS while maintaining the requirements defined in system architecture, segregation rules, and location details.

The same methodology, explained for a new component installed, can be followed responsive to any of the triggers; including when a new software is loaded at block 604, a new logic is deployed at block 606, a loading issue is identified at block 608, or other triggers that can be added to the load management algorithm. The trigger can also be passage of a time interval or user request.

The redistributed loading provided at block 628 is read at blocks 610, 618, and 620. A loop including blocks 616, 622, 624, 626, and 628 can be repeated until a determination is made at block 622 that the sizing requirement(s) are met. Once the sizing requirement(s) are met, at block 630, the load is managed (e.g., balanced or optimized). Management of the load includes applying the last revised loading determined at 624 to the actual industrial system 100.

It is noted that reading the redistributed loading (e.g., at blocks 610, 618, and 620) correlates to block 428 shown in FIG. 4, which represents the feedback loop following the implementation of the decisions made by the ML algorithms.

Triggers that trigger load management can be revised and improved by the ML engine over time as it continuously improves the orchestration process. Similarly, the ML engine can add types of input data to be used and/or constraints to be applied by flowchart 600 for performing the orchestration process, providing continuous improvement of the orchestration process (including the ML algorithm(s) used for the orchestration process).

It is noted that block 630 correlates to block 418 shown in FIG. 4, which represents the continuous improvements and retraining of the ML Algorithms (shown as ML algorithms 410 in FIG. 4).

The load management workflow represented by flowchart 600 is referred to as being configured to operate autonomously or semi-autonomously when it includes blocks that are configured to operate automatically once initial input is received, but may include one or more blocks that can be configured to allow or require user intervention.

With reference to FIG. 7, a flowchart 700 is illustrated of an example orchestration method for a root cause identification and/or predictive analytics workflow performed during orchestration. At block 708, input data including logs of PCS components received through blocks 702, 704, and 706 are continuously monitored. Additional input is provided at blocks 709, 711, and 714. The method is not limited to the types of input data shown. Other types of input data that are not shown can be used. At least one of the types of input data includes data about an aspect of controllers of a PCS (such as controllers 186 of PCS 101 shown in FIG. 1).

The example types of input data shown include presently system logs 702, network monitoring logs 704, and event logs 706 (such as logs 216 shown in FIG. 2). Inputs 702-706 can include running data and/or historical data. Real time analysis if inputs 702-706 and determination of actions in response to the analysis can be performed using running data captured and processed while the PCS is in operation. Historical data can be used in the real time analysis as well. The historical data can also be used for post-operation analysis and actions responsive to the analysis.

An ML engine (such as ML engine 104, shown in FIG. 1) is configured to continuously interface with system management (such as system management 150 shown in FIG. 1) to read the running system logs 702. System logs 702 capture the system messages received from any or all of the PCS components when they or their peripherals encounter issues or recover from issues. Text and format of the messages can be defined by the PCS components' manufacturers. Table 3 illustrates some example system messages that were captured.

TABLE 3

| MsgDateTime | MsgDescription |
|---|---|
| Mar. 2, 2021 4:51:35 PM | 01CF12 Process = PMAINT01CF12 PIOMAI 000002 Hardware Fault T1D35B(IT2) DIAGNOSTIC ERROR 0x0020 |
| Mar. 2, 2021 4:35:50 PM | 01CF12 Process = PMAINT01CF12 PIOMAI 000002 Hardware Fault T1D35B(IT2) DIAGNOSTIC ERROR 0x0024 |
| Mar. 2, 2021 4:27:42 PM | 01CF12 Process = PMAINT01CF12 PIOMAI 000002 Hardware Fault T1D35B(IT2) DIAGNOSTIC ERROR 0x0020 |
| Mar. 2, 2021 4:25:19 PM | 01CE01 Process = RedIM SYSMON -00218 PORTA and PORTB are ready |
| Mar. 2, 2021 4:22:44 PM | 01CE01 Process = RedIM SYSMON -00216 PORT B is failed |
| Mar. 2, 2021 4:19:34 PM | 01CE01 Process = RedIM SYSMON -00218 PORTA and PORTB are ready |
| Mar. 2, 2021 4:19:00 PM | 01CE01 Process = RedIM SYSMON -00216 PORT B is failed |
| Mar. 2, 2021 4:18:01 PM | 01CF12 Process = PMAINT01CF12 PIOMAI 000002 Hardware Fault T1D35B(IT2) DIAGNOSTIC ERROR 0x0024 |
| Mar. 2, 2021 4:13:27 PM | 01CF12 Process = PMAINT01CF12 PIOMAI 000002 Hardware Fault T1D35B(IT2) DIAGNOSTIC ERROR 0x0024 |
| Mar. 2, 2021 4:06:52 PM | 01CF12 Process = PMAINT01CF12 PIOMAI 000002 Hardware Fault T1D35B(IT2) DIAGNOSTIC ERROR 0x0024 |
| Mar. 2, 2021 4:06:42 PM | 01CE01 Process = RedIM SYSMON -00218 PORTA and PORTB are ready |
| Mar. 2, 2021 4:06:29 PM | 01CE01 Process = RedIM SYSMON -00216 PORT B is failed |
| Mar. 2, 2021 3:30:15 PM | 01CF12 Process = PMAINT01CF12 PIOMAI 000002 Hardware Fault T1D35B(IT2) DIAGNOSTIC ERROR 0x0024 |
| Mar. 2, 2021 3:11:26 PM | 01CF12 Process = PMAINT01CF12 PIOMAI 000002 Hardware Fault T1D35B(IT2) DIAGNOSTIC ERROR 0x0020 |

At block 703, the ML engine is configured to continuously read the diagnostic information of the PCS components from the system management. The diagnostic information reports counters and statuses collected from any or all of the PCS components. The PCS components can include component families. Each component family reports a specific set of counters and statuses correlated with function of PCS components included in the corresponding component family. The counters are periodically updated via a system management interface that interfaces with the system management. Table 4 illustrates some example counters of a component family that were read.

TABLE 4

| MsgDateTime | Component | Counter | Value |
|---|---|---|---|
| Mar. 2, 2021 3:54:32 AM | 01CE01 | Total Received Packets | 5555575 |
| Mar. 2, 2021 3:54:32 AM | 01CE01 | Total Transmitted Packets | 4444464 |
| Mar. 2, 2021 3:54:32 AM | 01CE01 | Collisions | 0 |
| Mar. 2, 2021 3:54:32 AM | 01CE01 | CRC Errors | 667 |
| Mar. 2, 2021 3:54:32 AM | 01CE01 | Resets | 0 |
| Mar. 2, 2021 3:54:32 AM | 01CE01 | Bad Ethernet Packets | 0 |
| Mar. 2, 2021 3:54:32 AM | 01CE01 | Ethernet Port Switchovers | 0 |
| Mar. 2, 2021 3:54:32 AM | 01CE01 | Transmits Deferred | 0 |
| Mar. 2, 2021 3:54:32 AM | 01CE01 | CPU Usage | 20% |
| Mar. 2, 2021 3:54:32 AM | 01CE01 | Memory Usage | 60% |
| Mar. 2, 2021 3:54:32 AM | 01CE01 | IPC Usage | 70% |
| Mar. 2, 2021 3:53:32 AM | 01CE01 | Total Received Packets | 5555566 |
| Mar. 2, 2021 3:53:32 AM | 01CE01 | Total Transmitted Packets | 4444455 |
| Mar. 2, 2021 3:53:32 AM | 01CE01 | Collisions | 0 |
| Mar. 2, 2021 3:53:32 AM | 01CE01 | CRC Errors | 666 |
| Mar. 2, 2021 3:53:32 AM | 01CE01 | Resets | 0 |
| Mar. 2, 2021 3:53:32 AM | 01CE01 | Bad Ethernet Packets | 0 |
| Mar. 2, 2021 3:53:32 AM | 01CE01 | Ethernet Port Switchovers | 0 |
| Mar. 2, 2021 3:53:32 AM | 01CE01 | Transmits Deferred | 0 |
| Mar. 2, 2021 3:53:32 AM | 01CE01 | CPU Usage | 25% |
| Mar. 2, 2021 3:53:32 AM | 01CE01 | Memory Usage | 58% |
| Mar. 2, 2021 3:53:32 AM | 01CE01 | IPC Usage | 70% |

At block 704, the ML engine is configured to continuously interface with a network management, such as network management 140 shown in FIG. 1) to read the running network logs, which capture network related events, e.g., with associated messages received from any or all PCS components when they or their peripherals encounter issues or recover from issues. The messages text and format can be defined by the component manufacturer. Table 5 illustrates some example network logs of network events that were read.

TABLE 5
<134> Aug 12 09:53:40 151.128.000.000 13DS2B vlan.msgs: Port 7 link UP at speed 100 Mbps and full-duplex
<134> Aug 12 09:53:40 151.128.000.000 13DS2A vlan.msgs: Port 15 link UP at speed 100 Mbps and full-duplex
<134> Aug 12 09:53:58 151.128.000.000 13DS2A vlan.msgs: Port 15 link down
<134> Aug 12 09:53:58 151.128.000.000 13DS2B vlan.msgs: Port 7 link down
<134> Aug 12 09:54:01 151.128.000.000 13DS2B vlan.msgs: Port 7 link UP at speed 100 Mbps and full-duplex
<134> Aug 12 09:54:01 151.128.000.000 13DS2A vlan.msgs: Port 15 link UP at speed 100 Mbps and full-duplex
<134> Aug 12 09:54:24 151.128.000.000 13DS2B vlan.msgs: Port 7 link down
<134> Aug 12 09:54:24 151.128.000.000 13DS2A vlan.msgs: Port 15 link down
<134> Aug 12 09:54:26 151.128.000.000 13DS2B vlan.msgs: Port 7 link UP at speed 100 Mbps and full-duplex
<134> Aug 12 09:54:26 151.128.000.000 13DS2A vlan.msgs: Port 15 link UP at speed 100 Mbps and full-duplex
<134> Aug 12 09:54:50 151.128.000.000 13DS2B vlan.msgs: Port 7 link down

At block 705, the ML engine 104 is configured to continuously interface with an alarms management (such as alarms management 130, shown in FIG. 1) to read process alarms, e.g., including associated messages. The term “process alarm” refers to an alert to the PCS operator of a process disturbance or deviation from operation targets. Process alarms require immediate response from the operator to correct the process performance or initiate maintenance. Table 6 illustrates some example process alarms that were read.

TABLE 6

| ALARMDATETIME | TAG | ALARMTYPE | ALARM_DESCRIPTION | PRIORITY | ALARM_VALUE | ENG_UNIT | CP |
|---|---|---|---|---|---|---|---|
| Jan. 1, 2021 0:01 | 31PIC118A | HIABS | HIGH PRESSURE | 3 | 15 | PSIG | 02CF03 |
| Jan. 1, 2021 0:01 | 93TI1325 | HIABS | HIGH TEMP | 3 | 200 | DEGF | 13CF06 |
| Jan. 1, 2021 0:02 | 06TI3639A | IOBAD | PNT 6 BAD | 3 | | | 12CF06 |
| Jan. 1, 2021 0:03 | 98GM0478C | STATE | RUNNING | 3 | | | 12CF09 |
| Jan. 1, 2021 0:03 | 98FI0140 | LOABS | LOW | 3 | 22 | GPM | 12CF09 |
| Jan. 1, 2021 0:03 | 98FI0141 | IOBAD | PNT 1 BAD | 3 | | | 12CF09 |
| Jan. 1, 2021 0:03 | 98FI0141 | IOBAD | PNT 1 BAD | 3 | | | 12CF09 |
| Jan. 1, 2021 0:03 | 98GM1005AR | STATE | STOPPED | 3 | | | 15CF01 |
| Jan. 1, 2021 0:03 | 98GM1009AR | STATE | STOPPED | 3 | | | 15CF02 |

At block 706, the ML engine 104 is configured to continuously interface with a security management (such as security management 160, shown in FIG. 1) to read running event logs 708, e.g., including associated messages. Table 7 illustrates some example running event logs 708 that were read.

TABLE 7

| Level | Date and Time | Source | Event ID | Task Category |
|---|---|---|---|---|
| Error | 24 Oct. 2018 14:27 | ASP.NET 2.0.50727.0 | 1301 | Web Event |
| Error | 24 Oct. 2018 14:25 | McAfee Endpoint Security | 3 | None |
| Information | 24 Oct. 2018 14:04 | VSS | 8224 | None |
| Error | 24 Oct. 2018 14:01 | Microsoft-Windows-CAPI2 | 513 | None |
| Information | 24 Oct. 2018 13:49 | SceCli | 1704 | None |
| Error | 24 Oct. 2018 13:25 | McAfee Endpoint Security | 3 | None |
| Error | 24 Oct. 2018 13:25 | McAfee Endpoint Security | 3 | None |
| Error | 24 Oct. 2018 13:25 | McAfee Endpoint Security | 3 | None |
| Information | 24 Oct. 2018 13:25 | Microsoft-Windows-Winlogon | 6000 | None |
| Information | 24 Oct. 2018 13:25 | Desktop Window Manager | 9027 | None |
| Information | 24 Oct. 2018 13:25 | Microsoft-Windows-User Profiles Service | 1530 | None |
| Information | 24 Oct. 2018 13:25 | Microsoft-Windows-Winsrv | 10001 | None |
| Information | 24 Oct. 2018 13:25 | Microsoft-Windows-Winlogon | 6000 | None |
| Information | 24 Oct. 2018 13:25 | pas Executive.MonitorLocks | 0 | None |

At block 709, the ML engine 104 is configured to continuously interface with software management to read an OAJ, such as OAJ 218 shown in FIG. 2. Table 8 illustrates some example entries in the OAJ that were read.

TABLE 8

| ActionDate Time | Operator | ActionTarget | OldValue | NewValue |
|---|---|---|---|---|
| Mar. 2, 2021 3:55:32 AM | Operator1 | UC01_LEAD:SINE.MA | Manual | Auto |
| Mar. 2, 2021 3:55:13 AM | Operator1 | UC01_LEAD:SINE.OUT | 20 | 40 |
| Mar. 2, 2021 3:55:01 AM | Operator1 | UC01_LEAD:SINE.MA | Auto | Manual |
| Mar. 2, 2021 3:54:32 AM | Operator1 | UC01_LEAD:SINE.MA | Manual | Auto |
| Mar. 2, 2021 3:53:05 AM | Operator1 | UC01_LEAD:SINE.LR | Local | Remote |
| Mar. 2, 2021 3:52:11 AM | Operator1 | UC01_LEAD:SINE.LR | Remote | Local |
| Mar. 2, 2021 3:51:32 AM | Operator1 | SCRIPT/config/AlarmPanel_Cfg | | |
| Mar. 2, 2021 3:49:42 AM | Operator1 | SCRIPT/hi/init.cmds | | |
| Mar. 2, 2021 3:56:32 AM | Operator2 | UC01_LEAD:SINE.INHIB | Reset | Set |
| Mar. 2, 2021 3:55:55 AM | Operator2 | UC01_LEAD:SINE.INHALM | 0003 | 0002 |
| Mar. 2, 2021 3:55:32 AM | Operator2 | UC01_LEAD:SINE.INHALM | 0001 | 0003 |
| Mar. 2, 2021 3:54:21 AM | Operator2 | UC01_LEAD:SINE.INHIB | Set | Reset |
| Mar. 2, 2021 3:53:52 AM | Operator2 | UC01_LEAD:SINE.INHIB | Reset | Set |
| Mar. 2, 2021 3:53:12 AM | Operator2 | SCRIPT/tmplts/butreload | | |
| Mar. 2, 2021 3:52:32 AM | Operator2 | SCRIPT/config/AlarmPanel_Cfg | | |
| Mar. 2, 2021 3:50:32 AM | Operator2 | SCRIPT/hi/init.cmds | | |

At block 708, inputs 702-706, which can include each anomaly (e.g., failure, of the PCS and its network), are analyzed in view of system diagnostic guidelines 714 and symptoms read at block 711 (which provide a collection of predefined symptoms and diagnostics guidelines (or other forms of design specifications)). The analysis detects the anomalies, which can include comparing the inputs to system diagnostic guidelines 714 and predefined symptoms read at block 711. The system diagnostics guidelines 714 can include, for example, an error code, a textual description of the error, and a textual corrective action for correcting the error. Additionally, operator actions read from the OAJ at block 709 are correlated (e.g., temporally and/or spatially) with the anomalies to provide a more complete view of the issue.

The symptoms initially read at block 711 are iteratively updated at blocks 712 and 722 based on processing diverse inputs 702-706 by the ML engine.

In this way, accuracy of the symptoms used for analysis at block 710 increases as the symptoms are revised. The revision process provides a holistic view of the issues identified at block 708 using probabilistic machine learning-conditional random fields (CRFs) model. While the ML engine is configured to start by using the symptoms provided at block 711, which can be a user-entered, predefined collection of symptoms, the ML engine is configured to drive a revision process in which the symptoms are refined and enriched with symptoms that are newly built at block 712 with the occurrence of failures and identified issues.

One or more of data obtained as input at blocks 709, 711, and 714 can be about the controllers of the PCS. For example, OAJ data read at block 709 can include journaled entries about actions by operators of the controllers of the PCS, and the predefined symptoms accessed at block 711 and/or the system diagnostics guidelines read at block 714 can pertain to the controllers of the PCS and/or the PAUE. Some or all of the system diagnostics guidelines read at block 714 can be input by a user or other source.

At block 708, the ML engine is configured to link (meaning correlates) some or inputs 702-706 and/or combines them in a chronological order based on their timestamps (e.g., date and time) and/or a spatial order based on their locations. The ML engine is configured to apply deep learning techniques for text classification, e.g., using natural language processing (NLP) and/or sentiment analysis, to assign a severity level (e.g., to messages associated with anomalies) and/or categorize the anomalies (e.g., as types of failures, errors, warnings and being normal). The ML engine is also configured to apply rule-based named-entity recognition and classification (NERC) to identify and/or locate system or network components associated with an anomaly. This can involve CRF NLP models.

At block 714, the ML engine is configured to build a comprehensive, consolidated collection of system diagnostic guidelines, which is provided as input, e.g., to block 710. The system diagnostic guidelines include diagnostic guidelines from diverse sources associated with any and/or all connected PCS components, including error codes and corresponding corrective actions. Examples of the diverse sources include sources about diagnostic guidelines for network components, I/O components, and controllers of and associated with the PCS. Alternative to building system diagnostics guidelines by the ML engine, the system diagnostic guidelines can be built using scripting techniques (e.g., to collect, combine, and reformat the data from various sources into a single source). Table 9, as an example of information from one or more sources, illustrates some example diagnostic guidelines that were built from source(s) of I/O diagnostic guidelines.

TABLE 9

| Detected Error Code | Detected Error Text | Corrective Action |
|---|---|---|
| 24 | Calibration G register changed to | |
| | 0xNNNNNN | |
| 25 | GIRUN stuck, recovering | |
| 26 | Group sample time overrun/recover | |
| 44 | AI Init Fail chN code 0xNNNN | HARD FAILURE DETECTED: A/D |
| | | converter hardware - Replace FBM |
| 60 | comms failure to valid config | HART device communication is unsuccessful on initial |
| | | startup with DVOPTS set to NOFAIL and not |
| | | NOALARM. No action required. |
| 61 | comms timeout | These indicate that the HART device has |
| | | communication timeouts with DVOPTS set to OCD. |
| | | HART Device fault detected. |
| 62 | Detected comms error cleared | No action required. (code 60 cleared) for DVOPTS set |
| | | to NOFAIL or OCD |
| 65 | Detected malfunction retry count | FBM has set device malfunction detected alarm |
| | exceeded | |
| 66 | Detected malfunction cleared | FBM has cleared device malfunction detected alarm |
| | | (code 65 cleared) |

It is noted that blocks 702, 704, 706, 709, 711, and 714 correlate to output from block 422 shown in FIG. 4, which is provided as input for processing by ML algorithms (shown as ML algorithms 410 in FIG. 4).

At block 710, the identified issues are analyzed in view of the data that has been received or read, in view of correlations (and/or by making additional correlations) and categorizations (and/or by making additional categorizations) that were made. The analysis includes a survey of time periods before and after the identified issues and links information from different input data included in the same time period. At block 712, based on the identified issues, the correlated operator actions, and the referenced diagnostics guidelines, predictive analytic symptoms are built for the issue. The predictive analytic symptoms are added to the collection of predefined symptoms (if they are not yet included) for future identification.

It is noted that blocks 708 and 710 correlate to block 414 shown in FIG. 4, which presents the analysis processed by ML algorithms (shown as ML algorithms 410 in FIG. 4).

At block 712, a symptom can be recognized by a repeated pattern of messages, events and diagnostic information that accompany different (e.g., each or a threshold percentage of) occurrences of the identified failure. For example, before each occurrence of “01CE01 Process=RedIM SYSMON-00216 PORT B” is failed, the counter below is incremented, as shown in Table 10 below. The symptom is built by taking into consideration the value of the counter, as incremented, that preceded the failure of the port.

TABLE 10

| | | |
|---|---|---|
| 01CE01 | CRC Errors | 667 |

The issues and symptoms are verified at block 715 to determine a root cause of the identified issues and/or at block 716 to determine possible solutions. These root causes can be output, similar to root causes identification 312 shown in FIG. 3. Using the comprehensive collection of system diagnostic guidelines and the analysis of the correlated data, the ML engine 104 is configured to identify the likely root causes of the identified issues and/or the possible solutions to recover from the issues. Table 11 illustrates some example identified failures and respective likely causes and possible solutions for each cause.

TABLE 11

| Failure | Likely Root Causes | Possible Solutions |
|---|---|---|
| Port B of | 01CE01 port B has hardware fault. | Replace the module |
| 01CE01 | The cable connected to port B is | Diagnose the cable and |
| failed | loose, disconnected or damaged. | replace if damaged |
| | The switch port connected to | Diagnose the switch port |
| | 01CE01 port B is malfunctioning | and replace if having |
| | | hardware fault |

At block 718, predictive analytics is performed of the collected input 702-706 by referencing to the collection of symptoms (which is continuously updated) to generate predictive alerts before component failures take place. The alerts can be determined and output, e.g., as predictive alerts 314 shown in FIG. 3. The ML engine can leverage the collection of symptoms, which can be a large collection of symptoms, to recognize early indications of failures and faults. This is demonstrated in the example above, in which it is determined that a specific counter is incremented to a specific value a time interval (e.g., a few hours or days) ahead of a specific failure. In another example, a particular system log message can be an indicator of a degradation of performance of a specific component. Once an early indication is recognized, the ML engine is configured to send a predictive alert with an advisement to apply a corrective action. The corrective action to prevent the component failure can be performed autonomously, optionally, with user approval, or can be implemented by the user. Table 12 illustrates some example predicted failures and predicted solutions associated with particular alerts.

TABLE 12

| Alert | Predicted Failure | Possible Solutions |
|---|---|---|
| 01CE01 | Port B of 01CE01 | Diagnose the module hardware |
| CRC Errors | will fail in few | and replace if damaged |
| counter | hours | Diagnose the connected cable |
| incremented | | and replace if damaged |
| | | Diagnose the switch port and |
| | | replace if having hardware fault |

Predictive analytics block 718 is configured to predict anomalies through log analytics and timeseries analytics techniques using ML algorithms, such as Autoregressive Integrated Moving Average (ARIMA) and Long Short-Term Memory (LSTM).

At block 720, a determination is made whether a desired state provided by issues prevention desired state 719 is reached, such as by determining whether the generated predictive alerts result in prevention of possible issues determined. It is noted that both the current state and the desired state can be dynamic. The current state can change as inputs 702-706 change, and the dynamic state can change due to continuous improvement performed at block 724.

Issues prevention desired state 719 can relate to the PCS operation without failure of any of the PCS components or with a reduced number of failures, such that the reduced number of failures of each component type meets its published data for mean time between failures (MTBF).

It is noted that block 719 correlates to block 420 shown in FIG. 4, which is provided as desired state for processing by ML algorithms (shown as ML algorithms 410 in FIG. 4).

It is also noted that block 720 correlates to block 416 shown in FIG. 4, which is provided as decision making of the ML algorithms (shown as ML algorithms 410 in FIG. 4).

If it is determined at block 720 that not all possible issues would be prevented, then at block 722, the symptoms determined at block 712 using predictive analytics are revised and the analysis at block 710 continues based on the revised symptoms. A loop including blocks 710, 712, 715, 716, 718. 720, and 722 can be repeated until a determination is made at block 720 that the issues can be prevented based on the revised symptoms. The loop can be performed using ML (such as by invoking algorithms executed by ML engine 104 shown in FIG. 1). The ML algorithms used can include, for example, deep learning for natural language processing (NLP) and probabilistic machine learning. The NLP can be used to understand content of input data that is in a textual format, such as the Logs, the OAJ and the system diagnostics guidelines.

If it is determined at block 720 that the possible issues could be prevented, then at block 724 a continual improvement is performed. The continuous improvement includes continuously revising inputs to the orchestration method, such as the diagnostic guidelines and/or the collection of symptoms, validation rules used to validate any adjustments that are made (before or after implementation), and continuously improving the ML algorithms. Improving the ML algorithms can include retraining the ML models using, for example, revised datasets. This can help prevent deterioration of accuracy of the ML models over time due to dynamics of the PCS. In another example, the ML algorithms can be improved by providing more efficient ML algorithms. This improvement process can be correlated to block 418 of FIG. 4.

Blocks 719, 720, and 722 can improve a level of accuracy of the collection of symptoms, increasing the possibility of achieving the issues prevention desired state. In one or more embodiments, if the issues prevention does not meet the desired state, the ML engine is configured to revise the symptoms collection by adding new symptoms or refining the existing symptoms and repeating the analysis to identify more early indications. This iterative process can be implemented by a self-supervised learning model.

It is noted that block 722 correlates to block 426 shown in FIG. 4, which represents implementation of decisions made by the ML Algorithms (shown as ML algorithms 410 in FIG. 4).

At block 724, the ML engine is configured to continue updating (e.g., improving) the collection of system diagnostic guidelines, such as by incorporating new guidelines and correlating more relevant solutions to symptoms or identified root causes. Additionally, at block 724, the collection of symptoms is continually updated (e.g., improved, such as by adding new symptoms and refining existing symptoms to achieve better performance of the PCS and to exceed the issues prevention desired state.

It is noted that block 724 correlates to block 418 shown in FIG. 4, which represents the continuous improvements and retraining of the ML Algorithms (shown as ML algorithms 410 in FIG. 4).

Logs or log data that trigger issue identification can be revised and improved by the ML engine over time as it continuously improves the orchestration process. Similarly, the ML engine can add types of input data to be used and/or constraints to be applied by flowchart 700 for performing the orchestration process, providing continuous improvement of the orchestration process.

The root cause identification and/or predictive analytics workflow represented by flowchart 700 is referred to as being configured to operate autonomously or semi-autonomously when it includes blocks that are configured to operate automatically once initial input is received, but may include one or more blocks that can be configured to allow or require user intervention.

With reference to FIG. 8, a flowchart 800 is illustrated of an example orchestration method for a misconfigurations identification and correction workflow performed during orchestration. Blocks 802, 804, 806, 808, and 810 include different possible types of input data that are continuously monitored and categorized at block 812. A change to the hardware configuration at block 802, a change to the software configuration at block 804, or a change to the logic configuration at block 806 can trigger performance of block 812.

The method is not limited to identification of a misconfiguration based on the types of input data shown. Other types of input data that are not shown could be used. At least one of the types of input data about configurations (see blocks 802, 805, 806, and 808) includes data about an aspect of a controller of the PCS (such as controllers 186 and PCS 101 shown in FIG. 1), as does the input data about at least one of the performance indicators and the guidelines.

The example types of input data shown include input data about configurations, including hardware configurations 802 (e.g., to a controller or equipment of the PCS or a PAUE, such as PAUE 190 shown in FIG. 1, or other components of the industrial system), software configurations 804 (e.g., of any components of the industrial system), and logic configurations 806 (e.g., of function blocks or other logic deployed on controllers of the PCS). Performance indicators 808 are signs of misconfigurations developing in the system. Configuration guidelines 810 (or other types of design specifications) are reference configuration rules that are generally maintained for a system configuration.

Some of the design specifications read at block 810 can be input by a user or other source. Configuration guidelines 810 can include, for example, a code for each rule, a textual description of the rule, and a textual corrective action for correcting a misconfiguration that does not comply with the rule. Block 812 receives the input data from blocks 802, 804, 806, 808, and 810 and categorizes the configurations. Categorizing the configurations cause a validation process to be more efficient. Validation rules used by the validation process for each of the identified categories are executed at block 814 to identify any misconfigurations. The validation rules provide rules for determining whether validation or successful.

The categorization of the different configurations can apply deep learning techniques for text classification and/or clustering, e.g., using NLP. The categorization can also apply rule-based named-entity recognition and classification (NERC) to locate the system components. This can involve CRF NLP models.

It is noted that blocks 802, 804, 806, 808, and 810 correlate to output from block 422 shown in FIG. 4, which is provided as input for processing by ML algorithms (shown as ML algorithms 410 in FIG. 4).

At block 814, the configurations can be validated against configuration guidelines using the validation rules. Table 13 illustrates some example configuration guidelines that were read.

TABLE 13

| GuidelineNo | GuidelineDescription |
|---|---|
| Guideline1 | HighRangeLimit must be greater than LowRangeLimit |
| Guideline2 | HighRangeLimit must be greater than |
| | HighHighAlarmLimit |
| Guideline3 | HighRangeLimit must be greater than HighAlarmLimit |
| Guideline4 | LowRangeLimit must be less than LowLowAlarmLimit |
| Guideline5 | LowRangeLimit must be less than LowAlarmLimit |
| Guideline6 | Source and destination of a FunctionBlock connection must |
| | have same Range |
| Guideline7 | Source and destination of a FunctionBlock connection must |
| | have same EngineeringUnit |

It is noted that block 814 correlates to block 414 shown in FIG. 4, which presents the analysis processed by ML algorithms (shown as ML algorithms 410 in FIG. 4).

At block 818, the identified misconfigurations are reported to the user, as shown below. At block 816, additional misconfiguration validation rules are generated based on the identified and validated misconfigurations. These rules are generated by a process of inference. Table 14 illustrates some example misconfigurations that were reported to the user:

TABLE 14
INCONSISTENCY:ACCUM EI1 does not match AIN EO1 (22)

| | | | |
|---|---|---|---|
| 15CF03 | 94K145A_CP3 | 94FQI305 | ACCUM EI1 does not match AIN E01 |
| 15CF03 | 94K145B_CP3 | 94FQI312 | ACCUM EI1 does not match AIN E01 |

INCONSISTENCY:ACCUM EI1 does not match AINR EO1 (1)

| | | | |
|---|---|---|---|
| 15CF05 | 94G178_CP5 | 94FQI200 | ACCUM EI1 does not match AINR E01 |

INCONSISTENCY:ACCUM HSCI1 does not match AIN HSCO1 (4)

| | | | |
|---|---|---|---|
| 14CF08 | R35UTIL_CP8 | CO_PWR_ACCUM | ACCUM HSCI1 does not match AIN HSCO1 |

INCONSISTENCY:PID HSCI1 does not match AINR HSCO1 (1)

| | | | |
|---|---|---|---|
| 21CF04 | 21CP04_SIM | PT126 | PID HSCI1 does not match AINR HSCO1 |

INCONSISTENCY:PIDA EI1 does not match AIN EO1 (40)

| | | | |
|---|---|---|---|
| 11CF08 | 83F304_CP8_N | 83AIC101A | PIDA EI1 does not match AIN E01 |

INCONSISTENCY:SWCH EI1 does not match AIN EO1 (15)

| | | | |
|---|---|---|---|
| 01CF10 | 990FFSTE_CPA | 99FY1213XB | SWCH EI1 does not match AIN E01 |
| 01CF10 | 990FFSTE_CPA | 99FY103XB | SWCH EI1 does not match AIN E01 |

INCONSISTENCY:Compound Alarm Group Empty for Block ABSGRP (248)

| | | | |
|---|---|---|---|
| 13CF04 | 96D106_CP4 | 96LY103 | Compound Alarm Group Empty for Block ABSGRP |
| 13CF08 | 93E109_CP8 | 93TS177A2 | Compound Alarm Group Empty for Block ABSGRP |

At block 820, the corrective actions for each identified misconfiguration (such as in accordance with a rule of the configuration guidelines 810 for which there is a lack of compliance) are reported to correct the respective misconfigurations that were identified and validated. Table 15 illustrates an example misconfiguration and reported corrective action are shown.

TABLE 15

| Misconfiguration | Category | Corrective Action |
|---|---|---|
| 35GERA01_M:FT122A | High High Alarm | Modify High High Alarm |
| High High Alarm | outside block range | Limit to be less than |
| | | High Range |

At block 822, the corrective actions are implemented on the actual industrial system. The method of implementation of the corrective actions, e.g., using orchestration tools. At block 824, the configurations (e.g., logic configurations 806, hardware configurations 802 or software configurations 804) are revalidated after implementation of the corrective actions.

The user implementation of the corrective actions can retrigger the algorithm, causing a new cycle of validation to be executed while monitoring the performance indicators.

It is noted that block 822 correlates to block 426 shown in FIG. 4, which represents the implementation of the decisions made by the ML Algorithms (shown as ML algorithms 410 in FIG. 4).

It is noted that block 824 correlates to block 428 shown in FIG. 4, which represents the feedback loop following the implementation of the decisions made by the ML algorithms.

With additional reference to FIG. 8A, graphical representations of a number of performance indicators of a PCS monitored over a 60 second time interval are shown. At graph 852, the controller CPU utilization is shown, a top plot 870 shows the percentage of the maximum frequency of the CPU and a bottom plot 872 shows the percentage of CPU total usage. At graph 856, a percentage of physical memory used is shown. A top plot 874 shows the percentage of memory total usage and a bottom plot 876 shows the memory hardware fault per second. At graph 860, an amount (measured in Kbps) of PCS network traffic is shown. The illustrated performance indicators can show that a corrective action was effective, when the performance indicator becomes within the desired state specified.

At block 826 a determination is made whether a desired state provided by performance indicators 825 is reached, such as by determining whether the performance of the actual industrial system has improved, such as by determining whether eliminating the identified misconfigurations has resulted in an improvement in performance (e.g., as indicated by performance indicators). It is noted that the desired state provided by block 825 corresponds to the output from desired state 420 shown in FIG. 4.

If the determination at block 826 is that the performance did not improve (indicating that unidentified misconfigurations still exist in the industrial system), the method continues at block 828. At block 828, the validation rules are revised. Revising the validation rules depends on which performance indicator is unimproved and/or a degree of nonconformance with expected performance.

It is noted that block 826 correlates to block 416 shown in FIG. 4, which presents the decision making by ML algorithms (shown as ML algorithms 410 in FIG. 4).

It is noted that both the current state and the desired state can be dynamic. The current state can change as inputs 802, 804, 806, and 808 change, and the dynamic state can change due to revisions of validation rules at block 828 continuous improvement performed at block 830.

The method then continues at block 814. A loop including blocks 814, 816, 818, 820, 822, 824, 826, and 828 is repeated until it is determined at block 826 that performance did improve sufficient to indicate that the misconfigurations were identified and satisfactorily corrected. The loop can be performed using ML (such as by invoking algorithms executed by ML engine 104 shown in FIG. 1). The ML algorithms used can include reinforcement learning (e.g., MARL), an algorithm to solve CSPs, and/or probabilistic ML.

If it is determined at block 826 that performance indicators are improved sufficiently to indicate that misconfigurations were adequately identified and corrected, then at block 830, a continual improvement is continually executed for adjusting the configuration guidelines, misconfigurations validation rules, categorization rules, categorization validation rules, and the ML algorithms. Improving the ML algorithms can include retraining the ML models using, for example, revised datasets and/or providing more efficient ML algorithms. This improvement process can be correlated to block 418 of FIG. 4.

It is noted that block 830 correlates to block 418 shown in FIG. 4, which represents the continuous improvements and retraining of the ML Algorithms (shown as ML algorithms 410 in FIG. 4).

The misconfigurations identification and correction workflow represented by flowchart 800 is referred to as being configured to operate autonomously or semi-autonomously when it includes blocks that are configured to operate automatically once initial input is received, but may include one or more blocks that can be configured to allow or require user intervention.

Configuration guidelines or configuration data that trigger categorization of a configuration can be revised and improved by the ML engine over time as it continuously improves the orchestration process. Similarly, the ML engine can add types of input data to be used and/or constraints to be applied by flowchart 800 for performing the orchestration process, thus providing continuous improvement of the orchestration process.

An example of a misconfiguration that could be identified and corrected by autonomous orchestration in accordance with the disclosed methods includes a scenario in which two components that communicate with one another, for example a proportional-integral-derivative controller (PID) controller using scaling of 1:100 that communicates with a function block (FB) of a second controller using scaling of 1:1000. A misconfiguration issue would arise and be detected when the PID controller and the second controller are connected, since they must use the same scaling. The scaling of at least one of these devices could be adjusted to correct the misconfiguration.

In another misconfiguration example, a controller is configured to unicast an alarm message to N destinations when a condition X is detected. However, a workstation that is included among the N destinations was removed without reconfiguring the controller. When the controller sends the alarm message to the workstation, the alarm message is not received. The controller is aware that the alarm message was not received and continues to rebroadcast the alarm message. The rebroadcasting causes an overload of the PCS network. This misconfiguration could be detected and corrected by updating the controller to no longer broadcast to the removed workstation.

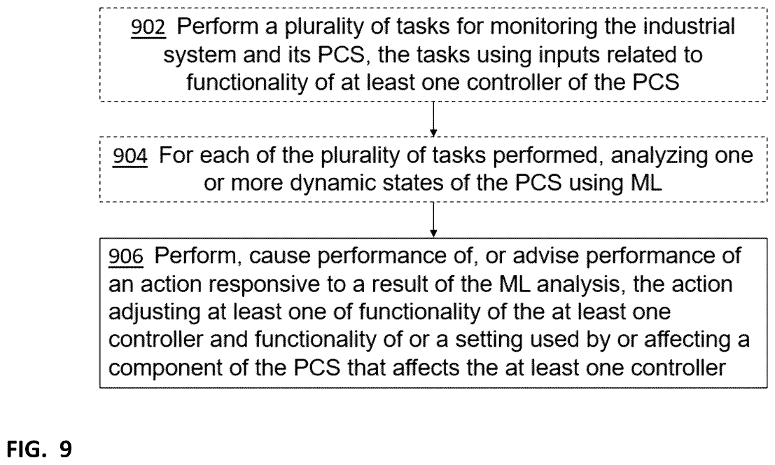

Referring to FIG. 9, a flowchart is shown of an example method for ML-based orchestration of an industrial system, such as industrial system 100 shown in FIG. 1. The industrial system includes a PCS, such as PCS 101 shown in FIG. 1. The PCS 101 includes at least one controller (such as controllers 186 shown in FIG. 1 (without limitation to a specific number of controllers)).

The controller has a control function that is related to a physical aspect of the PCS, such as for controlling a field device (such as field devices 191 shown in FIG. 1 (without limitation to a specific number of field devices)) of the industrial system. The field device can be, for example, an alarm, a sensor that senses a physical characteristic of the industrial system or an actuator that is configured to perform an action that affects a physical process of the industrial system. The method can be performed by an orchestration module (such as orchestration module 102 shown in FIG. 1) that uses an ML engine (such as ML engine 104, shown in FIG. 1). The method can be performed autonomously or semi-autonomously.

At block 902, a plurality of tasks are performed for monitoring the industrial system, including the PCS. Each of the plurality of tasks being performed uses a plurality of inputs, including inputs that are related to functionality of at least one controller of the PCS. The at least one controller includes at least one control function related to a physical aspect of the PCS.

At block 904, for each of the plurality of tasks performed, one or more dynamic states of the PCS and the PCS's at least one controller are analyzed using at least one ML algorithm. The one or more dynamic states are affected by the plurality of inputs.

At block 906, responsive to an output of the at least one ML algorithm, an action is performed, caused to be performed, or advised to be performed. The action adjusts at least one of functionality of the at least one controller and functionality of or a setting used by or affecting a component of the PCS that affects the at least one controller. Some examples of actions include adjusting loading, correcting a misconfiguration, implementation of decisions made by an ML engine, training the ML algorithm, performance of corrective actions (e.g., at block 822 of FIG. 8), implementation of solutions (e.g., at block 716 of FIG. 7), and continuous improvements (e.g., at block 724 of FIG. 7 and block 830 of FIG. 8).

In one or more embodiments, at least a portion of the multiple tasks can be performed at a same time. For example, two or more of the orchestration methods shown in the flowcharts of FIGS. 6-8, or other orchestration methods not shown, can be performed at the same time.

In one or more embodiments, the action can include an adjustment to loading of at least one of the PCS, a network of the PCS, and IPC between the at least one controller.

In one or more embodiments, a condition of the plurality of inputs can trigger performance of a task of the plurality of tasks.

In one or more embodiments, the condition can include at least one of installation within the PCS of a new physical component, installation of new software on a processing device of the PCS, deployment of new logic on the at least one controller that affects control of the one or more physical aspects of the PCS, and identification of a loading problem.

In one or more embodiments, the one or more dynamic states of the PCS can be based on at least one of: loading capacity of the at least one controller, current loading of the at least one controller, current loading of the PCS, segregation requirements of the PCS, system architecture of the PCS, current loading of the IPC, and current loading of the network of the PCS.

In one or more embodiments, the at least one ML algorithm can include at least one of an ML reinforcement algorithm, a constraint satisfaction algorithm, and a probabilistic ML algorithm.

In one or more embodiments, the action can be a corrective action for at least one of an identified present fault and/or failure and a predicted fault and/or failure, an update to a collection of symptoms indicative of a present or predicted fault and/or failure used to analyze the one or more dynamic states of the PCS, and/or a collection of diagnostic guidelines used to diagnostically analyze the one or more dynamic states of the PCS.

In one or more embodiments, the condition of the plurality of inputs can trigger performance of a task of the plurality of tasks, wherein the condition can include at least one of running and/or historical system logs of the PCS, running and/or historical network monitoring logs of a network used by the PCS, and running and/or historical event logs of events occurring and/or that occurred in association with operation of the PCS.

In one or more embodiments, the one or more dynamic states of the PCS can be based on at least one of: the collection of diagnostic guidelines, an operator action journal (OAJ) that describes timestamped operator actions associated with the at least one controller, and the collection of symptoms.

In one or more embodiments, the at least one ML algorithm can include at least one of deep learning for natural language processing and a probabilistic ML algorithm.

In one or more embodiments, the action can include at least one of correction of a detected misconfiguration associated with configuration of the PCS, adjustment to a collection of configuration guidelines for the PCS that are used for detecting misconfigurations associated with the configuration of the PCS, and adjustment to misconfiguration validation rules for validating the correction of the detected misconfiguration and/or the adjustment to the collection of configuration guidelines.

In one or more embodiments, a condition of the plurality of inputs can trigger performance of a task of the plurality of tasks, wherein the condition can include at least one of a hardware configuration of the PCS, a software configuration of the PCS, and a configuration of logic installed on the at least one controller.

In one or more embodiments, the one or more dynamic states of the PCS can be based on at least one of: performance indicators of the PCS and the collection of configuration guidelines of the PCS.

In one or more embodiments, the at least one ML algorithm can include at least one of an ML reinforcement algorithm, a constraint satisfaction algorithm, and a probabilistic ML algorithm.

In one or more embodiments, the method can be performed autonomously.

In one or more embodiments, analyzing the one or more dynamic states of the PCS using the ML algorithm can include analyzing the one or more dynamic states in view of one or more respective corresponding desired states.

In one or more embodiments, the one or more respective corresponding desired states can be dynamic.

In one or more embodiments, the action can further include adjustment to determination of a future action.

In one or more embodiments, an orchestration system is provided. The orchestration system includes at least one memory configured to store a plurality of programmable instructions and at least one processing device in communication with the memory. The processing device, upon execution of the plurality of programmable instructions can be configured to perform the method shown and described with respect to FIG. 9.

In one or more embodiments, a non-transitory computer readable storage medium and one or more computer programs embedded therein are provided. The computer programs comprising instructions, which when executed by a computer system, cause the computer system to perform the method shown and described with respect to FIG. 9.

Accordingly, any of the methods shown in FIGS. 4-8 can be used by orchestration module 102 using ML engine 104, shown in FIG. 1, to, for example without limitation, autonomously evenly distribute loads, such as the processing load, network traffic, and IPCs; monitor the PCS and the industrial system for failures and faults; identify root causes of failures and faults; advise performance of corrective actions to recover and/or eliminate faults; predict and report future faults and/or failures; advise and/or cause corrective actions to be performed to prevent predicted faults and/or failures; report misconfigurations; advise and/or cause corrective actions to be performed to clear misconfigurations; continuously improve misconfiguration rules and/or validation rules.

Potential advantages include simplified management of an industrial system with improved reliability and productivity; healthier components of the industrial system due to continual monitoring (e.g., around the clock) and proactive corrections before faults and failures arise or disrupt processes; improved overall system loading and performance; improved efficiency in running components of the industrial system, thereby reducing generated heat and cooling requirements; improved lifetime of components of the industrial system, thereby reducing environmental impact caused by disposal; reduced need for human resources and human error due to automated and autonomous procedural maintenance; and optimal performance of the industrial system, reduced disturbances or downtime of industrial system's plant.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions.

These computer program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart(s) and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational operations to be performed on the computer, other programmable apparatus or other devices to produce a computer implemented process such that the instructions which execute on the computer or other programmable apparatus provide processes for implementing the functions/acts specified in the flowchart and/or block diagram block or blocks.

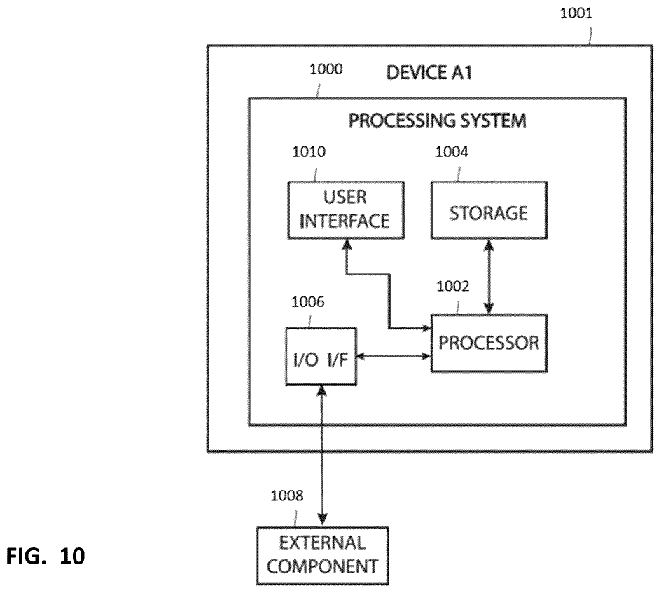

With reference to FIG. 10, a block diagram of an example processing system 1000 is shown, which provides an example configuration of a computing system used by computing components that provide orchestration of an industrial system (e.g., orchestration module 102 and ML engine 104, shown in FIG. 1). All or portions of the computing components of the industrial system, including its ML-based orchestration, could be configured as software, and processing system 1000 could represent such portions. Processing system 1000 is only one example of a suitable system and is not intended to suggest any limitation as to the scope of use or functionality of embodiments of the disclosure described herein. Processing system 1000 can be implemented using hardware, software, and/or firmware. Regardless, processing system 1000 is capable of being implemented and/or performing functionality as set forth in the disclosure.

Processing system 1000 is shown in the form of a general-purpose computing device. Processing system 1000 includes a processing device 1002, memory 1004, an input/output (I/O) interface (I/F) 1006 that can communicate with an internal component, such as a user interface 1010, and optionally an external component 1008.

In certain embodiments, processing device 1002 can access a neural network and/or include processing power that is suitable for artificial intelligence and machine learning tasks.

Memory 1004 can include, for example, volatile and non-volatile memory for storing data temporarily or long term, and for storing programmable instructions executable by the processing device 1002. Memory 1004 can be a removable (e.g., portable) memory for storage of program instructions. I/O I/F 1006 can include an interface and/or conductors to couple to the one or more internal components 1010 and/or external components 1008.

Embodiments of the computing components of the industrial system may be implemented or executed by one or more computer systems. Each processing system 1000 can be included within the computing components of the industrial system, or multiple instances thereof.

In certain embodiments, processing system 1000 is included in a larger system, such as system A1 1001. Portions of the processing system 1000 can be provided externally, such by way of an interface.

Processing system 1000 is only one example of a suitable system and is not intended to suggest any limitation as to the scope of use or functionality of embodiments of the disclosure described herein. Regardless, processing system 1000 is capable of being implemented to perform any of the functionality set forth hereinabove.

Processing system 1000 may be described in the general context of execution of computer system-executable instructions, such as program modules. Generally, program modules may include routines, programs, objects, components, logic, data structures, and so on that perform particular tasks or implement particular abstract data types.

In the preceding, reference is made to various embodiments. However, the scope of the present disclosure is not limited to the specific described embodiments. Instead, any combination of the described features and elements, whether related to different embodiments or not, is contemplated to implement and practice contemplated embodiments. Furthermore, although embodiments may achieve advantages over other possible solutions or over the prior art, whether or not a particular advantage is achieved by a given embodiment is not limiting of the scope of the present disclosure. Thus, the preceding aspects, features, embodiments, and advantages are merely illustrative and are not considered elements or limitations of the appended claims except where explicitly recited in a claim(s).

The various embodiments disclosed herein may be implemented as a system, method, or computer program product. Accordingly, aspects may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects may take the form of a computer program product embodied in one or more computer-readable medium(s) having computer-readable program code embodied thereon.

Any combination of one or more computer-readable medium(s) may be utilized. The computer-readable medium may be a non-transitory computer-readable medium. A non-transitory computer-readable medium may be, for example, but not limited to, an electronic, magnetic, optical, electromagnetic, infrared, or semiconductor system, apparatus, or device, or any suitable combination of the foregoing. More specific examples (a non-exhaustive list) of the non-transitory computer-readable medium can include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. Program code embodied on a computer-readable medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages. Moreover, such computer program code can execute using a single computer system or by multiple computer systems communicating with one another (e.g., using a local area network (LAN), wide area network (WAN), the Internet, etc.). While various features in the preceding are described with reference to flowchart illustrations and/or block diagrams, a person of ordinary skill in the art will understand that each block of the flowchart illustrations and/or block diagrams, as well as combinations of blocks in the flowchart illustrations and/or block diagrams, can be implemented by computer logic (e.g., computer program instructions, hardware logic, a combination of the two, etc.). Generally, computer program instructions may be provided to a processor(s) of a general-purpose computer, special-purpose computer, or other programmable data processing apparatus. Moreover, the execution of such computer program instructions using the processor(s) produces a machine that can carry out a function(s) or act(s) specified in the flowchart and/or block diagram block or blocks.

The flowchart and block diagrams in the Figures illustrate the architecture, functionality and/or operation of possible implementations of various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

It is to be understood that the above description is intended to be illustrative, and not restrictive. Many other implementation examples are apparent upon reading and understanding the above description. Although the disclosure describes specific examples, it is recognized that the systems and methods of the disclosure are not limited to the examples described herein but may be practiced with modifications within the scope of the appended claims. Accordingly, the specification and drawings are to be regarded in an illustrative sense rather than a restrictive sense. The scope of the disclosure should, therefore, be determined with reference to the appended claims, along with the full scope of equivalents to which such claims are entitled.

We claim:

1. A method of orchestration in an industrial system having a process control system (PCS), the method being performed autonomously or semi-autonomously and comprising:
performing a plurality of tasks for monitoring the industrial system, including the PCS, each of the plurality of tasks being performed using a plurality of inputs related to functionality of at least one controller of the PCS, the at least one controller having at least one control function related to a physical aspect of the PCS;
for each of the plurality of tasks performed, analyzing one or more dynamic states of the PCS and the PCS's at least one controller using at least one machine learning (ML) algorithm, the one or more dynamic states being affected by the plurality of inputs; and
performing, causing to be performed, or advising performance of an action responsive to an output of the at least one ML algorithm, the action adjusting at least one of functionality of the at least one controller, functionality of or a setting used by or affecting a component of the PCS that affects the at least one controller, inputs to the method of orchestration, and validation rules for validating an action before or after performance of the action.

2. The method of claim 1, wherein at least a portion of the multiple tasks are performed at a same time.

3. The method of claim 1, wherein the action includes an adjustment to loading of at least one of the PCS, a network of the PCS, and interprocess communication (IPC) between the at least one controller.

4. The method of claim 3, wherein a condition of the plurality of inputs triggers performance of a task of the plurality of tasks.

5. The method of claim 4, wherein the condition includes at least one of installation within the PCS of a new physical component, installation of new software on a processing device of the PCS, deployment of new logic on the at least one controller that affects control of the one or more physical aspects of the PCS, and identification of a loading problem.

6. The method of claim 3, wherein the one or more dynamic states of the PCS are based on at least one of: loading capacity of the at least one controller, current loading of the at least one controller, current loading of the PCS, segregation requirements of the PCS, system architecture of the PCS, current loading of the IPC, and current loading of the network of the PCS.

7. The method of claim 3, wherein the at least one ML algorithm includes at least one of an ML reinforcement algorithm, a constraint satisfaction algorithm, and a probabilistic ML algorithm.

8. The method of claim 1, wherein the action is a corrective action for at least one of an identified present fault and/or failure and a predicted fault and/or failure, an update to a collection of symptoms indicative of a present or predicted fault and/or failure used to analyze the one or more dynamic states of the PCS, and/or a collection of diagnostic guidelines used to diagnostically analyze the one or more dynamic states of the PCS.

9. The method of claim 8, wherein a condition of the plurality of inputs triggers performance of a task of the plurality of tasks, wherein the condition includes at least one of running and/or historical system logs of the PCS, running and/or historical network monitoring logs of a network used by the PCS, and running and/or historical event logs of events occurring and/or that occurred in association with operation of the PCS.

10. The method of claim 8, wherein the one or more dynamic states of the PCS are based on at least one of: the collection of diagnostic guidelines, an operator action journal (OAJ) that describes timestamped operator actions associated with the at least one controller, and the collection of symptoms.

11. The method of claim 8, wherein the at least one ML algorithm includes at least one of deep learning for natural language processing and a probabilistic ML algorithm.

12. The method of claim 1, wherein the action includes at least one of correction of a detected misconfiguration associated with configuration of the PCS, adjustment to a collection of configuration guidelines for the PCS that are used for detecting misconfigurations associated with the configuration of the PCS, and adjustment to misconfiguration validation rules for validating the correction of the detected misconfiguration and/or the adjustment to the collection of configuration guidelines.

13. The method of claim 12, wherein a condition of the plurality of inputs triggers performance of a task of the plurality of tasks, wherein the condition includes at least one of a hardware configuration of the PCS, a software configuration of the PCS, and a configuration of logic installed on the at least one controller.

14. The method of claim 12, wherein the one or more dynamic states of the PCS are based on at least one of: performance indicators of the PCS and the collection of configuration guidelines of the PCS.

15. The method of claim 12, wherein the at least one ML algorithm includes at least one of an ML reinforcement algorithm, a constraint satisfaction algorithm, and a probabilistic ML algorithm.

16. The method of claim 1, wherein analyzing the one or more dynamic states of the PCS using the ML algorithm includes analyzing the one or more dynamic states in view of one or more respective corresponding desired states.

17. The method of claim 16, wherein the one or more respective corresponding desired states are dynamic.

18. The method of claim 1, wherein the action further includes adjustment to determination of a future action.

19. An orchestration system of an industrial system having a process control system (PCS), the orchestration system comprising;
at least one memory configured to store a plurality of programmable instructions; and
at least one processing device in communication with the memory, wherein the processing device, upon execution of the plurality of programmable instructions is configured to, autonomously or semi-autonomously:
perform a plurality of tasks for monitoring the industrial system, including the PCS, each of the plurality of tasks being performed using a plurality of inputs related to functionality of at least one controller of the PCS, the at least one controller having at least one control function related to a physical aspect of the PCS;
for each of the plurality of tasks performed, analyze one or more dynamic states of the PCS and the PCS's at least one controller using at least one machine learning (ML) algorithm, the one or more dynamic states being affected by the plurality of inputs; and
perform, cause to be performed, or advise to perform an action responsive to an output of the at least one ML algorithm, the action adjusting at least one of functionality of the at least one controller and functionality of or a setting used by or affecting a component of the PCS that affects the at least one controller.

20. A non-transitory computer readable storage medium and one or more computer programs embedded therein, the computer programs comprising instructions, which when executed by a computer system, cause the computer system to, autonomously or semi-autonomously:
perform a plurality of tasks for monitoring an industrial system, including a process control system (PCS) of the industrial system, each of the plurality of tasks being performed using a plurality of inputs related to functionality of at least one controller of the PCS, the at least one controller having at least one control function related to a physical aspect of the PCS;
for each of the plurality of tasks performed, analyze one or more dynamic states of the PCS and the PCS's at least one controller using at least one machine learning (ML) algorithm, the one or more dynamic states being affected by the plurality of inputs; and
perform, cause to be performed, or advise to perform an action responsive to an output of the at least one ML algorithm, the action adjusting at least one of functionality of the at least one controller and functionality of or a setting used by or affecting a component of the PCS that affects the at least one controller.
